(19) United States
(12) Patent Application Publication
(10) Pub. No.: US 2022/0286361 A1
(43) Pub. Date: Sep. 8, 2022

(54) METHODS AND APPARATUS TO PERFORM COMPUTER-BASED COMMUNITY DETECTION IN A NETWORK

(71) Applicant: The Nielsen Company (US), LLC, New York, NY (US)

(72) Inventors: Kevin Li, Brooklyn, NY (US); Jan Laurens Geffert, New York, NY (US)

(21) Appl. No.: 17/687,426

(22) Filed: Mar. 4, 2022

Related U.S. Application Data
(60) Provisional application No. 63/157,411, filed on Mar. 5, 2021.

(51) Int. Cl. H04L 41/12; H04L 61/00; G06K 9/62

(52) U.S. Cl. CPC H04L 41/12; H04L 61/35; G06K 9/6218; G06K 9/6271

(57) ABSTRACT

Disclosed examples include at least one memory, instructions, and processor circuitry to execute the instructions to generate a device graph, the device graph to represent links between ones of personally identifiable information nodes and ones of device nodes, generate person-clusters based on the device graph, the person-clusters based on the links and community detection hyperparameter values, generate a node-to-person lookup structure based on the person-clusters, and deduplicate impression data based on the node-to-person lookup structure.

### RELATED APPLICATION

This patent arises from a patent application that claims the benefit of U.S. Provisional Patent Application No. 63/157,411, which was filed on Mar. 5, 2021. U.S. Provisional Patent Application No. 63/157,411 is hereby incorporated herein by reference in its entirety. Priority to U.S. Provisional Patent Application No. 63/157,411 is hereby claimed.

### FIELD OF THE DISCLOSURE

This disclosure relates generally to computer-based monitoring of network users and, more particularly, to methods and apparatus to perform computer-based community detection in a network.

### BACKGROUND

Entities can monitor access to media by users logged into Internet-based media providers. Such monitoring can be based on third-party cookies, mobile advertising identifiers, email addresses, internet protocol (IP) addresses, smart television identifiers, etc. However, monitoring data based on such alternative identifiers can misrepresent the true quantity of impressions.

### BRIEF DESCRIPTION OF THE DRAWINGS

FIG. 1 is a network-level diagram illustrating device users, computing devices, and a network community monitor of an audience measurement entity to collect media impressions.

FIG. 2A is a block diagram illustrating an example of how a cluster identity is determined.

FIG. 2B is a block diagram illustrating an example of how a duplicated impression is logged.

FIG. 3A is a block diagram illustrating an alternative example of how a cluster identity is determined.

FIG. 3B is a block diagram illustrating an alternative example of how a duplicate impression is logged.

FIG. 4 is an example device graph based on links between personally identifiable information and devices that illustrates how duplicate impressions are logged.

FIG. 5 is a block diagram of an example implementation of the example network community monitor of FIG. 1.

FIG. 6 is a flowchart representative of example machine readable instructions and/or example operations that may be executed by example processor circuitry to implement the example network community monitor of FIGS. 1, 2, 3, and/or 5 to deduplicate impressions.

FIG. 7 is a diagram illustrating the example data deduplication process of FIG. 6.

FIG. 8 is a diagram illustrating the example data deduplication process of FIG. 6 including demographic information.

FIGS. 9-10 are flowcharts representative of example machine readable instructions and/or example operations that may be executed by example processor circuitry to implement the example network community monitor of FIGS. 1, 2, 3, and/or 5 to deduplicate impressions.

FIG. 11 is a block diagram of an example processing platform including processor circuitry structured to execute the example machine readable instructions and/or the example operations of FIGS. 6, 9, and/or 10 to implement the example network community monitor of FIG. 1.

FIG. 12 is a block diagram of an example implementation of the processor circuitry of FIG. 11.

FIG. 13 is a block diagram of another example implementation of the processor circuitry of FIG. 11.

FIG. 14 is a block diagram of an example software distribution platform (e.g., one or more servers) to distribute software (e.g., software corresponding to the example machine readable instructions of FIGS. 6, 8, and/or 9) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” refer to dimensions that may not be exact due to manufacturing tolerances and/or other real world imperfections. As used herein “substantially real time” refers to occurrence in a near instantaneous manner recognizing there may be real world delays for computing time, transmission, etc. Thus, unless otherwise specified, “substantially real time” refers to real time+/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

Example methods and apparatus disclosed herein deduplicate media impressions via community detection. Historically, media impressions originate from a single source (e.g., televisions (TVs), radio) and could be tracked and recorded individually per user. More recently, consumers own and use multiple devices (e.g., computer, smart phone, smart TV, tablet) each with the ability to access media, complicating the accurate recording of media impressions.

When users access media across a variety of devices, it can be difficult to discern how many impressions have occurred. For example, a user could begin watching a television show on a phone, continue watching on a TV, and finish watching on a tablet. Previously, this problem was approached by using observed user sign-ins by subscribers of services provided by database proprietors (e.g., Facebook). The database proprietor could differentiate between distinct and repeated media impressions based on known user sign-ins. In addition, they could provide demographic data associated with the accounts to the audience measurement entity. With recent disruptions in the online advertising ecosystem including the blocking of third-party cookies and digital ad identifiers (e.g., IDFAs), alternative methods of matching users to media impressions are used, such as the use of personally identifiable information (PII) to device links. Throughout the description, “PII-to-device link” is sometimes referred to as “link”, the plural form “links,” “person-to-device link,” or “person-to-device association.”

One example of a PII-to-device link is the linking of hashed email addresses and their observed device sign-ins (e.g., a PII-to-device link), such as logins into email-associated third-party website and app accounts. In some examples, different types of person-to-device links may additionally or alternatively be used such as, for example, a PII-to-PII link (e.g., a link between an email address and a cookie ID). Unfortunately, the aggregation of hashed email addresses linked to devices can create large, connected components (LCCs). LCCs are clusters of devices connected to one another by known links (e.g., email sign-ins) and can contain thousands or millions of email addresses and devices. This is because, while hashed email addresses can be used as a proxy for impression identification, unlike database proprietor accounts, users often have more than one email address. In addition, email addresses associated with accounts for media consumption websites (e.g., New York Times, CNN.com, Netflix, Hulu, Amazon Prime Video, etc.) are often shared between individuals and devices, which can further obscure the true identity of the person associated with the impression. This lack of one-to-one match between users, devices, and PII can produce duplicated impressions, and thus, the true number of impressions can be misrepresented.

Duplicate impressions can be, in some examples, multiple impressions measured for one individual. For example, a duplicate impression can occur when the person accesses the same media item from both a first device and a second device (or from the same device), generating two impressions. The AME logs the two separate impressions as if the impressions are attributable to different people when, in fact, the two impressions correspond to the same person. In some examples, a duplicate impression includes multiple impressions merged into or attributed to one identity (e.g., an identity of a single person). Although not limited to the following, two examples of how duplicated impressions can develop are as follows. In a first example, a device or collection of devices are shared amongst multiple users such that the device ID cannot be assigned to one single person ID. When each user signs into the shared device, their person ID and impressions become associated with the device. When these person IDs and impressions become aggregated over many different users, it is unknown to which person ID the impressions should be assigned. Therefore, an AME may associate all impressions corresponding to each of the multiple users with a single, merged cluster identity. In this case, if more than one user of the multiple users accesses the same media, the impressions are associated with the same cluster identity and the AME considers the impressions as duplicate impressions.

In a second example, one-off sign-on events can produce erroneous links. In this case, a link between the person ID and the device ID is observed and is correct at the moment it was observed. However, it is incorrect over time. A one-off use is not a strong enough link to determine ownership of the device ID and impression. This is further confirmed when sign-ins introduce new PII not previously associated with the device. However, the AME may still associate all impressions corresponding to the one-off sign-on with the device ID to a single, merged cluster identity. In this case, if the person originally associated with the device ID and the person associated with the one-off sign on both access the same media, the impressions are associated with the same cluster identity and the AME considers the impressions as duplicate impressions.

Such example behaviors can produce duplicated impressions. The impressions can be properly attributed to the correct person and deduplicated by observing how frequently PII interact with distinct devices relative to the other devices in the LCC and grouping together those that interact most frequently. In some examples, properly attributing and deduplicating impressions relies on assuming each device has a primary user, even if that user does not solely interact with the selected device. Once properly attributed and deduplicated, the data can provide a reference for which impressions are correlated with each person. The device-to-person relationship and inferred ownership information may also be used to assign or infer demographic variables of the device user.

Example approaches disclosed herein access link impression data from a database proprietor. Example links can include email addresses, cookie IDs, mobile ad IDs (AAID, IDFA), UID 2.0, smart TV IDs, IP addresses (IPv4 & IPv6), ZIP 11, Names, Addresses, and third-party IDs such as Experian ID (PID, LUID), or any combination, variation (e.g., a portion of an email address), or derivation thereof (e.g., a hashed representation of an email address). The links are used to form a graph of all devices where each device is represented by a single node and is linked by PII to other associated devices represented by other nodes in the graph.

Example approaches disclosed herein deduplicate the impression data using a device graph that is created using a community detection algorithm. Using a full device graph, an initial value of an objective function of the algorithm is calculated. For each node, possible “moves” (e.g., the allocation of the given node to the community of a neighboring node) are found. For each move, the change in the objective function value is calculated. Based on the changes to the objective function, nodes are switched from the original community to the community that maximizes the objective function and combined into new community clusters. This is repeated until convergence of the algorithm. Utilization of the community detection algorithm leads to grouping together nodes that interact more amongst themselves than with nodes in other communities. After convergence, at the point of deduplication, communities represent one or more devices and/or one or more PII (e.g., hashed email addresses) assigned to a single user.

Example approaches disclosed herein utilize hyperparameters within the objective function. One example of a hyperparameter affects average community size. Another example of a hyperparameter affects edge equity. In some examples, the community detection algorithm is repeated with varying values of one or more of the hyperparameters to further maximize the objective function. This may be repeated until convergence of the algorithm. In other examples, the objective function is negatively dependent on an entropy value of each community cluster. In other words, the objective function is maximized when the entropy value of each community cluster is minimized.

Upon the completion of the community detection process, the communities of each node are saved, and a snapshot including a node-to-person lookup structure (e.g., a node-to-person lookup table, a node-to-person assignments table, etc.) is created. This snapshot can be used for the deduplication of impression data from the device level to the person level. The snapshot is, in some examples, compared with known panelist data for accuracy, quality, and stability over time. The deduplicated data is analyzed to determine if the number of persons associated with each device is nominal, and to see how many devices change their person ID or demographic assignment over time. The deduplicated data is used for user identification and audience measurement.

Using examples disclosed herein, by receiving and deduplicating impression data and preparing an ID resolution snapshot, the resulting deduplicated media impressions can be more accurately utilized than duplicated data. In addition, this can be achieved without relying solely on prior methods of impression collection such as using database proprietors, third-party cookies or ad identifiers. Deduplicated impressions more accurately represent which individuals are linked to which devices. Additionally, aggregations of previously deduplicated media impressions can be compared to recently deduplicated impressions and panelist data to determine relative accuracy and consistency of the recent data. This method of data deduplication is more versatile than alternatives as any data that provides PII-to-device links (or any other type of links) can be used.

As used herein, an impression is defined to be an event in which a home or individual accesses and/or is exposed to media (e.g., an advertisement, content, a group of advertisements and/or a collection of content). In Internet media delivery, a quantity of impressions or impression count is the total number of times media (e.g., content, an advertisement, or advertisement campaign) has been accessed by a web population or audience members (e.g., the number of times the media is accessed). In some examples, an impression or media impression is logged by an impression collection entity (e.g., an AME or a database proprietor) in response to an impression request from a user/client device that requested the media. For example, an impression request is a message or communication (e.g., an HTTP request) sent by a client device to an impression collection server to report the occurrence of a media impression at the client device. As used herein, a demographic impression is defined to be an impression that is associated with a characteristic (e.g., a demographic characteristic) of a person attributed with accessing the media. For example, an AME or a database proprietor can generate a demographic impression by associating an audience member's demographic information with an impression for the media accessed at a client device. In some examples, a media impression is not associated with demographics. In non-Internet media delivery, such as television (TV) media, a television or a device attached to the television (e.g., a set-top-box or other media monitoring device) may monitor media being output by the television. The monitoring generates a log of impressions associated with the media displayed on the television. The television and/or connected device may transmit impression logs to the impression collection entity to log the media impressions.

A user of a computing device (e.g., a mobile device, a tablet, a laptop, etc.) and/or a television may be exposed to the same media via multiple devices (e.g., two or more of a mobile device, a tablet, a laptop, etc.) and/or via multiple media types (e.g., digital media available online, digital TV (DTV) media temporarily available online after broadcast, TV media, etc.). For example, a user may start watching a particular television program on a television as part of TV media, pause the program, and continue to watch the program on a tablet as part of DTV media. In such an example, the exposure to the program may be logged by an AME twice, once for an impression log associated with the television exposure, and once for the impression request generated by a tag (e.g., census measurement science (CMS) tag) executed on the tablet. Multiple logged impressions associated with the same program and/or same user are defined as duplicate impressions. Duplicate impressions are problematic in determining total reach estimates because one exposure via two or more cross-platform devices may be counted as two or more unique audience members. As used herein, reach is a measure indicative of the demographic coverage achieved by media (e.g., demographic group(s) and/or demographic population(s) exposed to the media). For example, media reaching a broader demographic base will have a larger reach than media that reached a more limited demographic base. The reach metric may be measured by tracking impressions for known users (e.g., panelists or non-panelists) for which an audience measurement entity stores demographic information or can obtain demographic information. Deduplication is a process that is used to adjust cross-platform media exposure totals by reducing (e.g., eliminating) the double counting of individual audience members that were exposed to media via more than one platform and/or are represented in more than one database of media impressions used to determine the reach of the media.

As used herein, a unique audience is based on audience members distinguishable from one another. That is, a particular audience member exposed to particular media is measured as a single unique audience member regardless of how many times that audience member is exposed to that particular media or the particular platform(s) through which the audience member is exposed to the media. If that particular audience member is exposed multiple times to the same media, the multiple exposures for the particular audience member to the same media is counted as only a single unique audience member. As used herein, an audience size is a quantity of unique audience members of particular events (e.g., exposed to particular media, etc.). That is, an audience size is a number of deduplicated or unique audience members exposed to a media item of interest of audience metrics analysis. A deduplicated or unique audience member is one that is counted only once as part of an audience size. Thus, regardless of whether a particular person is detected as accessing a media item once or multiple times, that person is only counted once as the audience size for that media item. In this manner, impression performance for particular media is not disproportionately represented when a small subset of one or more audience members is exposed to the same media an excessively large number of times while a larger number of audience members is exposed fewer times or not at all to that same media. Audience size may also be referred to as unique audience or deduplicated audience. By tracking exposures to unique audience members, a unique audience measure may be used to determine a reach measure to identify how many unique audience members are reached by media. In some examples, increasing unique audience and, thus, reach, is useful for advertisers wishing to reach a larger audience base.

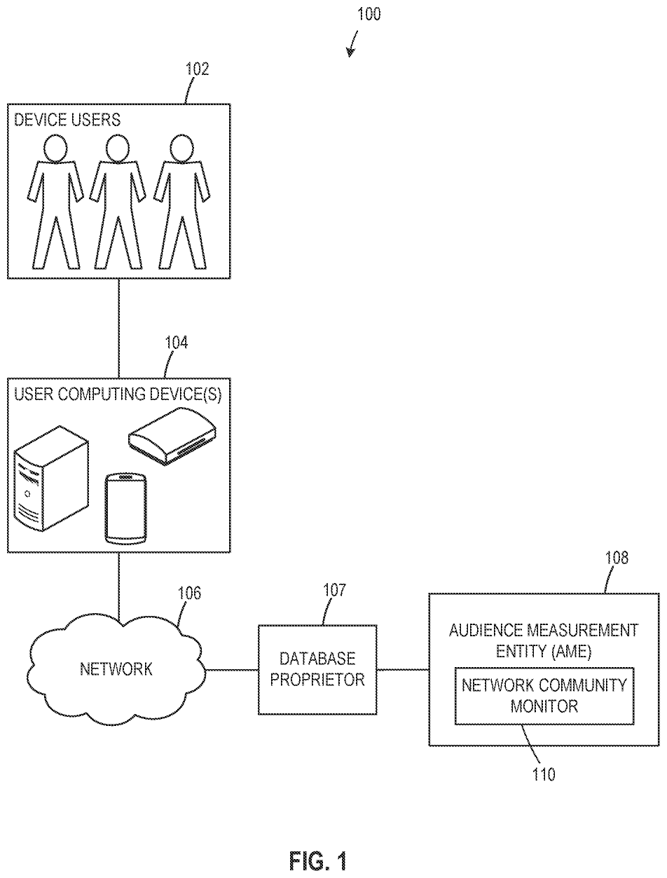

FIG. 1 is an example network-level diagram 100 illustrating interaction between example device users 102, example user computing devices 104, an example network 106, an example database proprietor 107, an example audience measurement entity (AME) 108, and an example network community monitor 110 to collect media impressions. The example device users 102 are any individuals who access and interact with media using, for example, the user computing devices 104, and/or access media over the network 106. Media can be any digital content (e.g., website, video, music, video game, podcast, audio book, e-book, online gambling, television show, movie, etc.). In some examples, the device users 102 are panelist participants and contribute their impression data and demographic information to the AME 108. As used herein, panelists are users (e.g., one or more of the device users 102) registered on panels maintained by a ratings entity (e.g., an audience measurement company) that owns and/or operates a system for monitoring accesses to media. That is, an entity such as an audience measurement entity enrolls people that consent to being monitored into a panel. During enrollment, the audience measurement entity receives demographic information from the enrolling people so that subsequent correlations may be made between advertisement/media accesses by those panelists and different demographic markets. Such correlations for accessed media may be logged as demographic impressions. For example, the audience measurement entity can generate a demographic impression by associating a panelist's demographic information with an impression for the media accessed at a client device associated with that panelist. In other examples, the device users 102 are anonymous individuals, or are both panelist participants and anonymous individuals. The device users 102 interact with the user computing devices 104 and generate impressions through their activity.

The user computing devices 104 communicate data across the network 106 to the AME 108. In some examples, the user computing device 104 is capable of directly presenting media (e.g., via a display) while, in other examples, the user computing device 104 presents the media on separate media presentation equipment (e.g., speakers, a display, etc.). Thus, as used herein “computing devices” may or may not be able to present media without assistance from a second device. Computing devices are typically consumer electronics. For example, the user computing device 104 of the illustrated example can be a personal computer such as a laptop computer, and thus, is capable of directly presenting media (e.g., via an integrated and/or connected display and speakers). While in the illustrated example, personal computing devices are shown, any other type(s) and/or number(s) of media device(s) may additionally or alternatively be used. For example, Internet-enabled mobile handsets (e.g., a smartphone, an iPod® music player, etc.), video game consoles (e.g., an Xbox® game console, a PlayStation® game console, etc.), tablet computers (e.g., an iPad® tablet device, an Android® tablet device, etc.), digital media players (e.g., a Roku® media player, a Slingbox® media player, a Tivo® media player, etc.), smart televisions, desktop computers, laptop computers, servers, etc. may additionally or alternatively be used. The data communicated via the network 106 to the AME 108 are media impressions with one or more links (e.g., PII-to-device links).

The example network 106 of FIG. 1 is the Internet. However, the example network 106 may be implemented using any other network over which data can be transferred (e.g., private network, Virtual Private Network, the Internet, Local Area Network, Wide Area Network, wireless network, cellular network, etc.). In some examples, the network 106 is not always connected to the user computing devices 104. In other examples, the user computing devices 104 send data to the network 106 continuously, at regular intervals, and/or upon request.

The example database proprietor 107 of FIG. 1 is an online service provider with which the device users 102 can be registered users (e.g., social media company, cloud server manager, etc.) The database proprietor 107 collects data about the device users 102 (e.g., demographics, location, impressions, etc.). In some examples, the database proprietor 107 provides online advertisement tracking to third parties, like the AME 108. In other examples, the device users 102 are not registered users with the database proprietor 107 but may still interact with media associated with, or be tracked by the database proprietor 107.

The example AME 108 stores and processes data transferred from the user computing devices 104. The example AME 108 can be, in some examples, a media monitoring company. Media monitoring companies desire knowledge on how users interact with media devices such as smartphones, tablets, laptops, smart televisions, etc. In particular, media monitoring companies want to monitor media accessed by the media devices to, among other things, monitor exposure to advertisements, determine advertisement effectiveness, determine user behavior, identify purchasing behavior associated with various demographics, etc. Data transferred to the audience measurement entity 108 may be edited and may also be deleted or stored after it is used. In some examples, impression data is transferred to the AME 108 from the database proprietor 107. The data from the example database proprietor 107 can include demographic data associated with the device users 102. Example FIG. 1 shows a connection between the device users 102 and the user computing devices 104 which represents that many different device users 102 may be interacting with many different user computing devices 104. For clarity, example FIG. 1 shows the device users 102 as including three distinct example users, and the user computing devices 104 as including three unique example devices with a connection between them. This represents that at any given time multiple example users and example devices may be interacting. In addition, any quantity of example devices may be communicating with the AME 108 over the network 106.

The network community monitor 110 of the illustrated example of FIG. 1 is a server, computer, and/or other computing environment operated by the AME 108. The example network community monitor 110 receives and processes the impression data from an AME server of the AME 108. In some examples, the data is modified by the AME server of the AME 108 before being transferred to network community monitor 110. In other examples, the data from the database proprietor 107 is combined with additional data by the AME server of the AME 108. Data can be provided to the network community monitor 110 for example, at regular intervals or upon request.

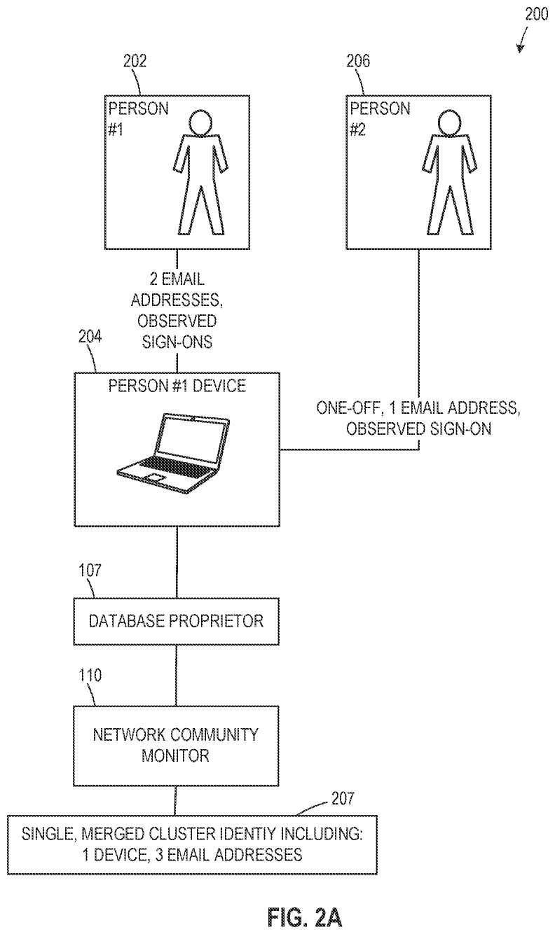

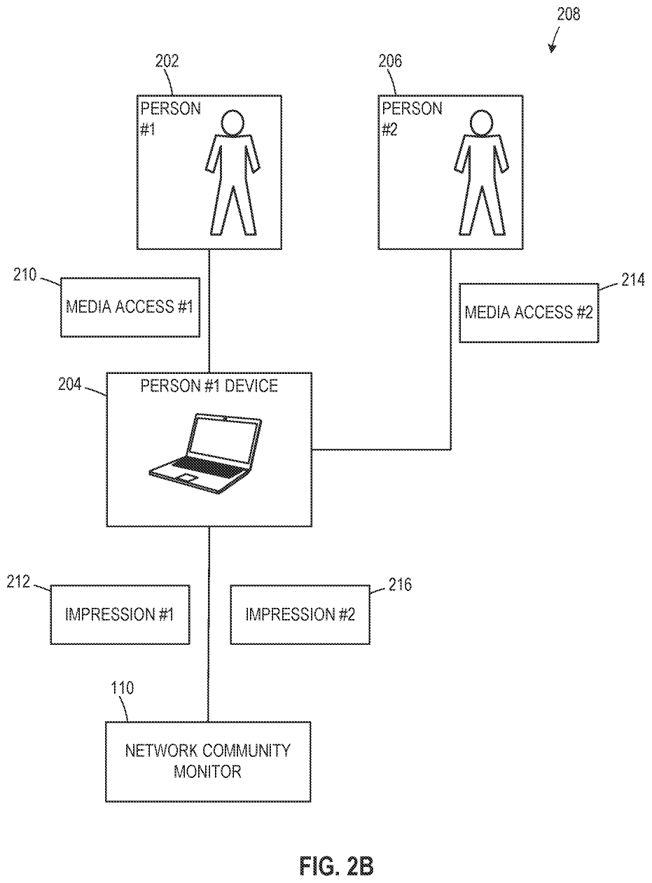

FIG. 2A is a block diagram 200 illustrating how an example cluster identity is determined by the network community monitor 110. A person #1 202 uses two email addresses and interacts with, and signs-in to a person #1 device 204. As person #1 202 uses person #1 device 204 over time, sign-ins and interactions are observed based on the person #1 device 204, the database proprietor 107 generates links between the person #1 device 204 and the two email addresses and transmits these links to the network community monitor 110. Thus, the network community monitor 110 of the AME 108 (FIG. 1) creates a strong association between an ID of person #1 202 and an ID of the person #1 device 204. When a person #2 206 signs in with their email address in a one-off, observed sign-in, a new link (e.g., association) is created connecting person #1 202 and person #2 206 with person #1 device 204. This association or link between the two persons 202, 206 and the person #1 device 204 causes the network community monitor 110 to generate a single, merged cluster identity 207, the cluster identity 207 associated with one device and three email addresses. As a result of the generation of the single, merged cluster identity 207, the network community monitor 110 associates any impressions associated with either of the one device and/or any of the three email addresses to the single, merged cluster identity 207. In some examples, because of the strong association of the ID of person #1 202 and the person #1 device 204, the single, merged cluster identity 207 is associated with the ID of person #1 202. In FIG. 2A, sign-ins to email accounts based on email addresses are used as an example interaction that produces links (e.g., associations) between one or more persons and a device. In examples disclosed herein, such a link (or association) between one or more persons and a device is represented using a PII-to-device link.

FIG. 2B is a block diagram 200 illustrating how an example duplicated impression is logged and sent to the network community monitor 110. In FIG. 2B, person #1 202, while signed in using one of the two email addresses of FIG. 2A, accesses media on the person #1 device 204 generating media access #1 210. The media access #1 210 generates an impression #1 212 that is logged by the network community monitor 110. Additionally, person #2 206, while signed in using the email address of FIG. 2A, accesses the same media on the person #1 device 204 generating media access #2 214. The media access #2 214 generates an impression #2 216 that is logged by the network community monitor 110. Because of the generation of the single, merged cluster identity 207 (FIG. 2A), the network community monitor 110 associates both impression #1 212 and impression #2 216 for the same media with the single, merged cluster identity 207. That is, although the impression #1 212 corresponds to person #1 202 and the impression #2 216 corresponds to person #2 206, both of the impressions are associated with the single, merged cluster identity 207. Therefore, those two impressions (e.g., impression #1 212 and impression #2 216) are interpreted as a duplicate impression because they are logged as both for the same media and corresponding to the single, merged cluster identity 207, which is representative of person #1 202. For example, during an impression deduplication process, the example AME 108 perceives the two logged impressions of the same media as duplicate impressions because they are attributed to the same cluster identity 207. That is, since two or more impressions for the same media attributed to the same cluster identity are perceived as duplicative for a same person, logged impressions are deduplicated to avoid duplicate or multiplicative counting of same-person impressions as separate audience members when determining a unique audience size (e.g., an audience of unique persons that accessed media). In example FIG. 2B, during the deduplication process, the AME 108 deduplicates the two impressions 212, 216 to be represented as a single impression. However, since the originally logged two impressions 212, 216 did actually correspond to the two different persons 202, 206 illustrated in FIGS. 2A and 2B, the deduplication process actually removes a true impression. This creates a misrepresentation of the audience size for the media as being smaller than it actually is (e.g., an erroneous audience size of one rather than the correct audience size of two). When processing impressions from the person #1 device 204, one or more impressions attributable to person #2 206 should be associated with a separate cluster identity than the single, merged cluster identity 207.

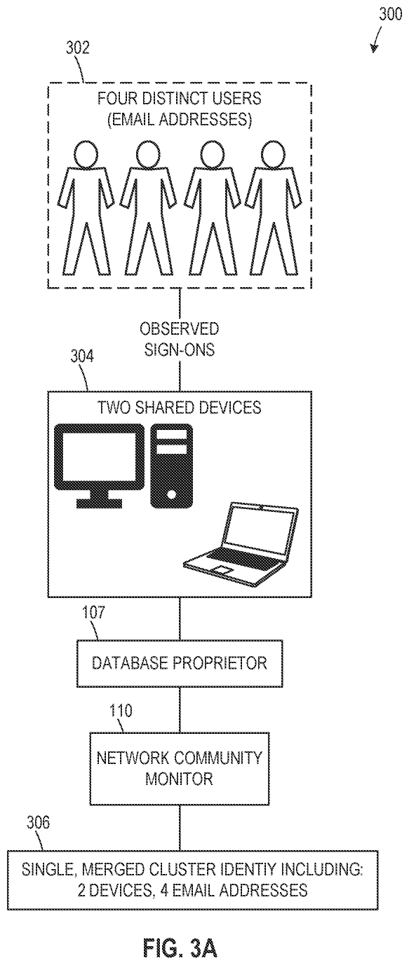

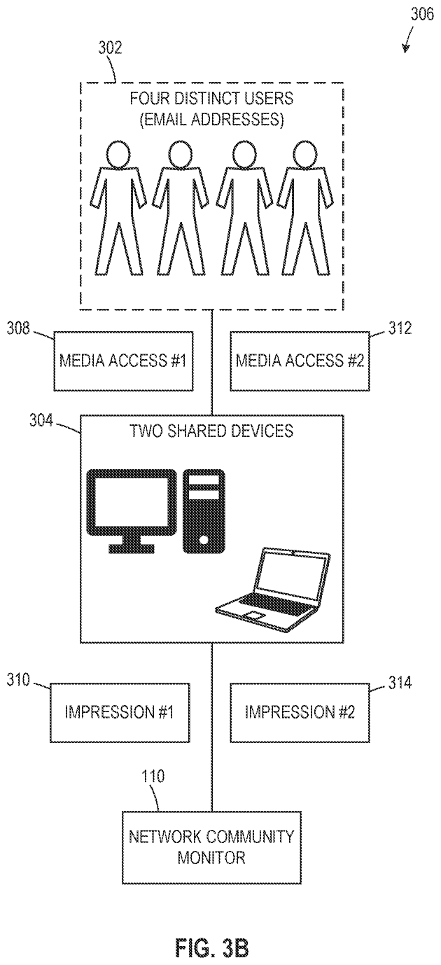

FIG. 3A is a block diagram 300 illustrating how a second example cluster identity is determined by the network community monitor 110. Example FIG. 3 shows four distinct users 302 that use a number of email addresses and interact with two shared devices 304 on an ongoing basis. Device interactions of the four distinct users 302 are associated with the two shared devices 304 and produce user identification through monitoring user sign-in or login events. The device interactions of multiple users with multiple shared devices are collected as links by the database proprietor 107 and transmitted to the network community monitor 110. The example network community monitor 110 uses the links to generate a single, merged cluster identity 306, the cluster identity associated with two devices and four email addresses. As a result of the generation of the single, merged cluster identity 306, the example network community monitor 110 associates any impressions associated with any of the two devices and/or any of the four email addresses to the single, merged cluster identity 306. For clarity, in FIG. 3 four distinct users 302 is an example number of users and two shared devices 304 is an example number of shared devices. This is merely representative and at any given time fewer or more different example users may interact with fewer or more example devices. In addition, any quantity of example shared devices may communicate with the AME 108 over the network 106. In FIG. 3A, sign-ins to email accounts based on email addresses are used as an example interaction that produces associations or links between users and devices. In examples disclosed herein, such a link (or association) between one or more persons and a device is represented using a PII-to-device link.

FIG. 3B is a block diagram 300 illustrating how a second example duplicated impression is logged and sent to the network community monitor 110. In FIG. 3B, one of the four distinct users 302, while signed in using one of the four email addresses, accesses media on one of the two shared devices 304 generating media access #1 308. The media access #1 308 generates an impression #1 310 that is logged with the network community monitor 110. Additionally, a second one of the four distinct users 302, while signed in using one of the four email addresses, accesses the same media on one of the two shared devices 304 generating media access #2 312. The media access #2 312 generates an impression #2 314 that is logged with the network community monitor 110. Because of the generation of the single, merged cluster identity 306 (FIG. 3A), the network community monitor 110 associates both impression #1 310 and impression #2 314 for the same media with the single, merged cluster identity 306. Therefore, those two impressions (e.g., impression #1 310 and impression #2 314) are interpreted as a duplicate impression because they are logged as both for the same media and corresponding to the single, merged cluster identity 306, which is representative of a single one of the four distinct users 302. For example, during an impression deduplication process, the same AME 108 perceives the two logged impressions of the same media as duplicate impressions because they are attributed to the same cluster identity 306. That is, since two or more impressions for the same media attributed to the same cluster identity are perceived as duplicative for a same person, logged impressions are deduplicated to avoid duplicate or multiplicative counting of same-person impressions as separate audience members when determining a unique audience size. In example FIG. 3B, during the deduplication process, the AME 108 deduplicates the two impressions 310, 314 to be represented as a single impression. However, since the originally logged two impressions 310, 314 did actually correspond to two different persons of the four distinct users 302, the deduplication process actually removes a true impression. This creates a misrepresentation of the audience size for the media as being smaller than it actually is (e.g., an erroneous audience size of one rather than the correct audience size of two). When processing impressions from the two shared devices 304, one or more impressions attributable to the second one of the four distinct users 302 should be associated with a separate cluster identity than the single, merged cluster identity 306.

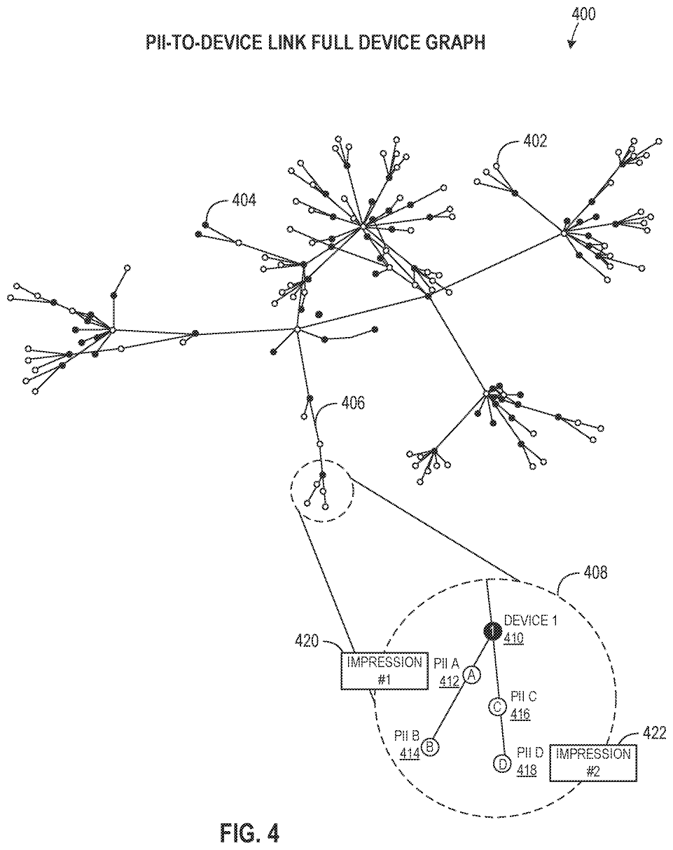

FIG. 4 is an example device graph 400 created from PII-to-device links that illustrates how duplicate impressions are logged. In the example device graph 400, links (e.g., PII-to-device links) are shown. In the example device graph 400 of FIG. 4, hashed email addresses are represented by empty or non-filled nodes 402, and devices are represented by shaded or filled nodes 404. In examples disclosed herein, a non-filled node 402 is referred to as a PII node 402, and a filled node 404 is referred to as a device node 404. Example FIG. 4 shows the PII nodes 402 and device nodes 404 as connected by lines that represent observed sign-ins. In examples disclosed herein, the sign-ins are based on email addresses. However, examples disclosed herein are not limited to using email addresses for identifying people. Instead, examples disclosed herein may be used with any other user identifier including, for example, usernames, telephone numbers, account numbers, cookie IDs, mobile ad IDs (Android Advertising ID (AAID), Identifier for Advertisers (IDFA), User ID (UID) 2.0, smart TV IDs, IP addresses (IPv4 & IPv6), ZIP 11, Names, Addresses, and third-party IDs such as Experian ID (Precise ID (PID), Living Unit ID (LUID)), etc., or any combination, variation (e.g., a portion of an email address), or derivation thereof (e.g., a hashed representation of an email address). As such, while hashed email addresses are used as example PII, PII are not limited to hashed emails for PII-to-device links but may be hashed versions of any of the above example types of identifiers. In the example device graph 400, devices and hashed email address interactions connect and associate many more devices than could plausibly be owned or used by a single person.

Examples disclosed herein split the graph components (e.g., the nodes representing hashed email addresses, the nodes representing devices) of a device graph (e.g., the device graph 400) into person-clusters using community detection. The example AME 108 (FIG. 1) can use the generated person-clusters to deduplicate impression data. For example, using a community detection process, the AME 108 may generate a person-cluster 408 as illustrated in FIG. 4. The example person-cluster 408 includes device 1 410, PII A 412, PII B 414, PII C 416 and PII D 418. The example AME 108 can associate the person-cluster 408 with a unique person-cluster identity. As such, any impression corresponding to any of the nodes of the person-cluster 408 is associated by the AME 108 with the unique person-cluster identity of the person-cluster 408. For example, the AME 108 may log impression #1 420 corresponding to PII A 412 for a given media. Because PII A 412 is a part of person-cluster 408, the AME 108 associates impression #1 420 with the unique person-cluster identity of person-cluster 408. Additionally, the example AME 108 can log impression #2 422 corresponding to PII D 418 for the same media. Because PII D 418 is also a part of person-cluster 408, the example AME 108 also associates impression #2 422 with the unique person-cluster identity of person-cluster 408. Therefore, the example AME 108 identifies the two impressions (e.g., the impression #1 420, the impression #2 422) as duplicate impressions because they are logged for the same media and are both associated with the same unique person-cluster identity. As such, during a deduplication process, the example AME 108 deduplicates the two impressions (e.g., impression #1 420 and impression #2 422) to be represented as a single impression to accurately determine the unique audience size of the media.

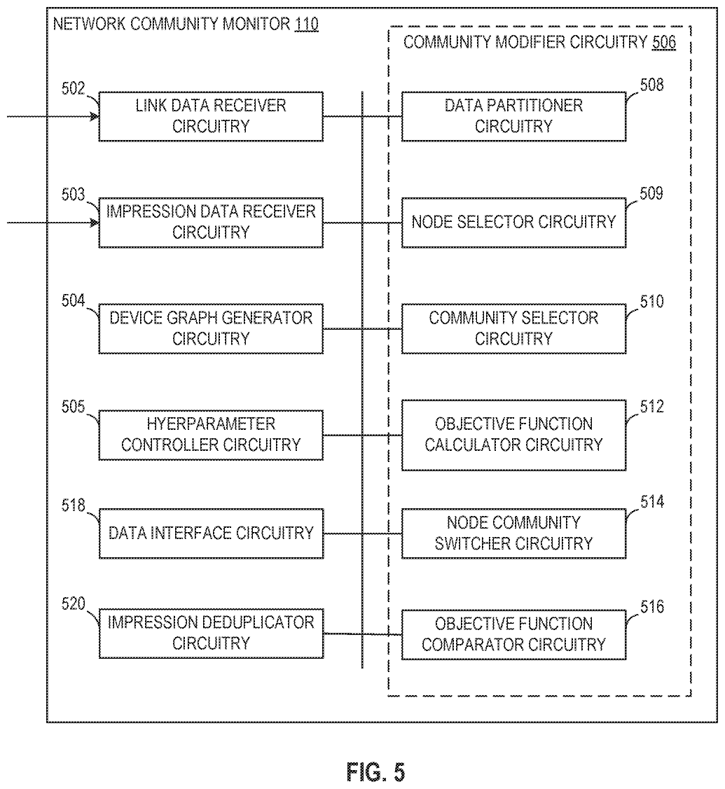

FIG. 5 is a block diagram of the example network community monitor 110 to perform community detection and/or deduplicate impressions based on identified person-clusters. The example network community monitor 110 of FIG. 5 may be instantiated (e.g., creating an instance of, bring into being for any length of time, materialize, implement, etc.) by processor circuitry such as a central processing unit executing instructions. Additionally or alternatively, the example network community monitor 110 of FIG. 5 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 5 may, thus, be instantiated at the same or different times. Some or all of the circuitry may be instantiated, for example, in one or more threads executing concurrently on hardware and/or in series on hardware. Moreover, in some examples, some or all of the circuitry of FIG. 5 may be implemented by one or more virtual machines and/or containers executing on the microprocessor.

The example network community monitor 110 includes link data receiver circuitry 502, impression data receiver circuitry 503, device graph generator circuitry 504, hyperparameter controller circuitry 505, community modifier circuitry 506, data partitioner circuitry 508, node selector circuitry 509, community selector circuitry 510, objective function calculator circuitry 512, node community switcher circuitry 514, objective function comparator circuitry 516, data interface circuitry 518, and impression deduplicator circuitry 520.

The example link data receiver circuitry 502 receives link data (e.g., PII-to-device links) from the database proprietor 107. Each of the PII-to-device links of the link data includes a PII node and a device node linked together based on observed interactions. In some examples, the link data receiver circuitry 502 receives link data from a plurality of database proprietors. The link data can include any personally identifiable information that is linked to a device including email addresses, cookie IDs, mobile ad IDs (AAID, IDFA), UID 2.0, smart TV IDs, IP addresses (IPv4 & IPv6), ZIP 11, Names, Addresses, and third-party IDs such as Experian ID (PID, LUID), or any combination, variation (e.g., a portion of an email address), or derivation thereof (e.g., a hashed representation of an email address). In some examples, the links include demographic information (e.g., gender, age, age range, location, etc.) associated with the PII and/or the device. The example link data receiver circuitry 502 receives the link data from database proprietor 107 for example, over the internet, via cloud-based storage, or via a server. In some examples, the link data is received continually as sign-in events occur. In other examples, the link data is received in bulk at regular intervals, and/or upon request.

The example impression data receiver circuitry 503 receives impression data indicative of user accesses to media. In some examples, the impression data is received from one or more database proprietors (e.g., the database proprietor 107). In other examples, the impression data is received directly from devices. Each impression of the impression data is attributed to either PII (e.g., a hashed email address) or to a device. As such, the impression data can be mapped to the PII nodes and/or the device nodes of the link data received by the link data receiver circuitry 502.

The example device graph generator circuitry 504 graphs the link data (e.g., PII-to-device links). In some examples, the example device graph generator circuitry 504 produces a device graph similar to the example device graph 400 of FIG. 4. The example device graph generator circuitry 504 can be implemented to output the device graph visually or can be implemented to structure and prepare the data for community detection.

The example community modifier circuitry 506 splits graph components (e.g., PII nodes, device nodes, etc.) of a device graph into person-clusters using community detection. In some examples, the community modifier circuitry 506 implements the data partitioner circuitry 508, the node selector circuitry 509, the community selector circuitry 510, the objective function calculator circuitry 512, the node community switcher circuitry 514, and the objective function comparator circuitry 516 to split graph components into person-clusters. The example community modifier circuitry 506 can split the graph components into person-clusters by maximizing a modularity (e.g., a degree to which a community interacts among itself relative to other communities) of the device graph.

The example community modifier circuitry 506 can use a hybrid objective function to quantify the modularity of a community and/or a device graph of communities. An example hybrid objective function is shown in example Equation 1 below in which Q represents the modularity of the device graph, C represents the communities within the device graph, e_{c} represents a sum of edges within a community c, γ (gamma) represents a first hyperparameter, 2m represents a total number of edges in the device graph, a (alpha) represents a second hyperparameter, k_{c} represents a sum of the degree of the nodes in community c, k̅ represents an average value of k_{c} across all communities, and n_{c} represents a number of nodes in community c.

$$Q = {\sum }_{C} [ {e}_{C} - \frac{γ}{2 m} ( α ( {k}_{c}^{2} - {( \overline{k} {n}_{c} )}^{2} ) + {( \overline{k} {n}_{c} )}^{2} ] \qquad ( Equation 1 )$$

As explained above, in some examples, the PII-to-device links include demographic information associated with the PII and/or the device. In some examples, the demographic information may be used to assist in the community detection process. For example, person-clusters may be formed such that each person-cluster is homogeneous (e.g., all devices and/or PII of the person-cluster are members of the same demographic) or has increased homogeneity. As used herein, homogeneity of a device graph is defined by example Equation 2 below in which h represents homogeneity, S(L|C) represents an entropy of a labeling L within a clustering C, and S(L) represents a natural entropy of a device graph with the labeling L. In order to maximize homogeneity, the entropy of each cluster should be decreased. As such, a hybrid objective function including a node homogeneity (e.g., entropy) function such as shown in example Equation 3 below can be used. In example Equation 3, the modularity is penalized for each community based on the entropy of the community for a given labeling (S_{c}(Lₚ). By maximizing the modularity of a device graph using the hybrid objective function of Equation 3, a homogeneity of the device graph is also maximized.

$$h = 1 - \frac{S ( L \vert C )}{S ( L )} \qquad ( Equation 2 )$$

$$Q = {\sum }_{C} [ {e}_{c} - \frac{γ}{2 m} ( α ( {k}_{c}^{2} - {( \overline{k} {n}_{c} )}^{2} ) + {( \overline{k} {n}_{c} )}^{2} - {\sum }_{p} {λ}_{p} {S}_{C} ( {L}_{p} ) ] \qquad ( Equation 3 )$$

Some known objective functions experience a resolution-limit problem in which as a size of the total device graph grows, community sizes (e.g., a number of devices per person-cluster) also grow. For example, some prior objective functions, when used to perform community detection on a device graph corresponding to a region including 2 million residents, may result in an average person-cluster including two devices. However, using the same prior objective functions to perform community detection on a device graph corresponding to a region including 10 million residents may result in an average person-cluster including four devices. Because it is not expected that the number of devices per person should increase based on a population size of a region, this is an artifact of the prior objective functions known as the resolution-limit problem.

In other prior objective functions, the resolution-limit problem is overcome by quantifying the degree to which communities interact with themselves while including as few nodes in the community as possible. However, in using these prior objective functions, a number of devices per person-cluster may be overly consistent (e.g., having a low variance) across person-clusters. In other words, the known objective function tends to assign a similar number of devices per person-cluster. However, it is not expected that each user (e.g., person-cluster) will be associated with the same number of devices. For example, in using these prior objective functions, a person that shows strong evidence to have five devices may be split into multiple person-clusters because the objective function has determined that the average number of devices per person-cluster is only three.

The example objective functions shown in example Equation 1 and example Equation 3 utilize the hyperparameters gamma and alpha to provide flexibility to modulate (e.g., tune) the hybrid objective function. The example hyperparameters alpha and gamma can be varied to combat both the resolution-limit problem and the restricted cluster variance problem of known objective functions. For example, increasing the hyperparameter gamma can discourage cluster growth while decreasing the hyperparameter gamma can encourage cluster growth. In another example, increasing the hyperparameter alpha can encourage cluster size variance while decreasing the hyperparameter alpha can decrease cluster size variance. The example hyperparameter controller circuitry 505 can initialize a value, increase a value, or decrease a value of one or more of the hyperparameters (e.g., gamma, alpha).

To begin performing community detection, the example data partitioner circuitry 508 partitions the device graph data into communities, where each community begins as a single device. In some examples, devices can be linked to many different devices via PII or can be linked to one other device only. In some examples, the data partitioner circuitry 508 preserves a snapshot of the initial device graph and the communities and links contained in the snapshot.

Next, the example node selector circuitry 509 selects a node to be modified by the community selector circuitry 510, the objective function calculator circuitry 512, the node community switcher circuitry 514, and the objective function comparator circuitry 516. In some examples, the node selector circuitry 509 selects a first listed node, and, in other examples, the node selector circuitry 509 determines which node to select based on which nodes have already been selected and/or those that can be used to best simplify the link data.

Next, the example community selector circuitry 510 selects a community to be modified by the objective function calculator circuitry 512, the node community switcher circuitry 514 and the objective function comparator circuitry 516. For example, the community selector circuitry 510 can select a community that is a neighbor (e.g., directly connected) to the node selected by the node selector circuitry 509. In some examples, the community selector circuitry 510 selects a first listed neighboring community, and in other examples the community selector circuitry 510 determines which community to select based on which communities have already been selected and/or those that can be used to best simplify the link data.

The example objective function calculator circuitry 512 evaluates the link data based on a set mathematical formula to evaluate the goodness of a given community partition for the device graph. In some examples, the objective function calculator circuitry 512 utilizes the hybrid objective function of Equation 1 to quantify the degree to which communities interact among themselves relative to other communities. In other examples, when the PII-to-device links include demographic information, the objective function calculator circuitry 512 utilizes the hybrid objective function including node homogeneity of Equation 3 to quantify the degree to which communities interact among themselves relative to other communities. The example objective function calculator circuitry 512 can utilize all or a portion of the link data. In some examples, the objective function calculator circuitry 512 calculates the change in the objective function for each device graph modification initiated by the node community switcher circuitry 514.

The example node community switcher circuitry 514 switches one or more nodes from the selected community to another (e.g., a neighboring) community. After the switching, the objective function calculator circuitry 512 can calculate the change in objective function from each move (e.g., switch). In some examples, the selected node is isolated (e.g., removed from any community) prior to being evaluated for movement to a neighboring community. For each neighboring community of a node, the example objective function calculator circuitry 512 can calculate a change in the hybrid objective function (e.g., a change in modularity) resulting from moving the node to the neighboring community. In some examples, the change in the hybrid objective function (e.g., the change in modularity) resulting from moving the isolated node to the neighboring community is calculated. For example, example Equation 4 below can be used to determine a change in modularity when adding isolated node (i) to a neighboring community (Cⱼ). In example Equation 4, Δq(i, Cⱼ) represents a change in modularity when adding isolated node (i) to community Cⱼ, k_{i,c}_{ⱼ} represents a sum of edges between node (i) and the neighboring community, kᵢ represents a degree (e.g., a number of connections) of the node (i), k_{c}_{ⱼ} represents a degree (e.g., a number of internal connections, a sum of the degree of each of the nodes within a community) of the neighboring community, β represents 1−α, k̅ represents an average value of the degrees of the nodes of the device graph, nᵢ represents a number of internal vertices in the node (i), and n_{c}_{ⱼ} represents a number of nodes of the neighboring community.

$$Δ q ( i , {C}_{j} ) = {k}_{i , {C}_{j}} - \frac{γ}{m} [ α {k}_{i} {k}_{{C}_{j}} + β {\overline{k}}^{2} {n}_{i} {n}_{{C}_{j}} ] \qquad ( Equation 4 )$$

In some examples, a change in modularity when adding the isolated node (i) to a neighboring community (Cⱼ) can be calculated while accounting for node homogeneity in the clusters if demographic information is associated with the PII and/or the device. In these examples, example Equation 5 can be used to calculate the change in modularity (Δq (i,C_{j,L})) when adding the isolated node (i) to a neighboring community (Cⱼ). Using example Equation 5, a change in entropy (e.g., the opposite of node homogeneity) when adding the isolated node (i) to the neighboring community (Cⱼ) is accounted for by adding the entropy of the neighboring community (Cⱼ) with the isolated node (i) added and subtracting the original entropy of the neighboring community (Cⱼ). In example Equation 5, S_{c}_{ⱼ}(L) represents the entropy of the neighboring community (Cⱼ) with a given labeling (L) as defined in example Equation 6, and S_{c+(i)}(L) represents the entropy of the neighboring community (Cⱼ) with a given labeling (L) including node (i) as defined in example Equation 7. In example Equation 6, α_{l,c} represents a number of nodes with label (l) in cluster (c). In example Equation 7, α_{l,c} is increased by δ_{l,c} where δ_{l,c} has equals one if node (i) label (l) and δ_{l,c} equals zero if node (i) does not have label (l).

$$Δ q ( i , {C}_{j , L} ) = Δ q ( i , {C}_{j} ) + {S}_{{C}_{j + \{ i \}}} ( L ) - {S}_{{C}_{j}} ( L ) \qquad ( Equation 5 )$$

$${S}_{{C}_{j}} ( L ) = - {\sum }_{L} {a}_{l , c} log ( \frac{{a}_{l , c}}{{Σ}_{l} {a}_{l , c}} ) \qquad ( Equation 6 )$$

$${S}_{{C}_{j} + \{ i \}} ( L ) = - {\sum }_{L} {a}_{l , c} log ( \frac{{a}_{l , c}}{{Σ}_{l} {a}_{l , c}} ) \qquad ( Equation 7 )$$

Once all possible moves have been attempted, the example node community switcher circuitry 514 rearranges the nodes of the device graph based on the results of the objective function. In some examples, the node community switcher circuitry 514 can switch all possible nodes to a new community, while in other examples, not all nodes have their locations modified. Nodes can be switched into other large communities of nodes or can exist as their own community individually. After the example node community switcher circuitry 514 rearranges the nodes of the device graph, the example objective function calculator circuitry 512 can determine an updated modularity value of the updated device graph.

The example objective function comparator circuitry 516 records and compares the modularity value determined by the objective function calculator circuitry 512 to the original modularity value of the device graph. Once all iterations are complete, the example objective function comparator circuitry 516 can perform a final check to confirm if the results meet or exceed the desired outcome of the objective function. In some examples, the objective function comparator circuitry 516 can determine that no change (or only insignificant change) in objective function result occurred from switching anode, while in other examples, the objective function comparator circuitry 516 determines that a change did occur.

The example data interface circuitry 518 saves the final device graph with the generated person-clusters. In some examples, the data interface circuitry 518 creates a node-to-person lookup structure (e.g., a snapshot lookup table, a node-to-person lookup table, a node-to-person assignments table, etc.) including all device nodes and all PII nodes and their corresponding person IDs based on the generated person-clusters. In some examples, the data interface circuitry 518 saves the final device graph data only temporarily.

The example impression deduplicator circuitry 520 deduplicates impression data based on the node-to-person lookup structure. As explained above, the impression data received by the impression data receiver circuitry 503 can be mapped to the nodes of the link data received by the link data receiver circuitry 502. Because each of the impressions can be mapped to the nodes of the link data, the impression deduplicator circuitry 520 can utilize the node-to-person lookup structure to determine a person ID (e.g., a person-cluster identity) associated with each of the impressions. If the example impression deduplicator circuitry 520 identifies any duplicated impressions (e.g., two or more impressions for the same media associated with the same person ID), the impression deduplicator circuitry 520 can deduplicate the two or more impressions to be represented as a single impression. The deduplicated impressions can be used to accurately determine the unique audience size of the media. In some examples, the data interface circuitry 518 stores the deduplicated impression data.

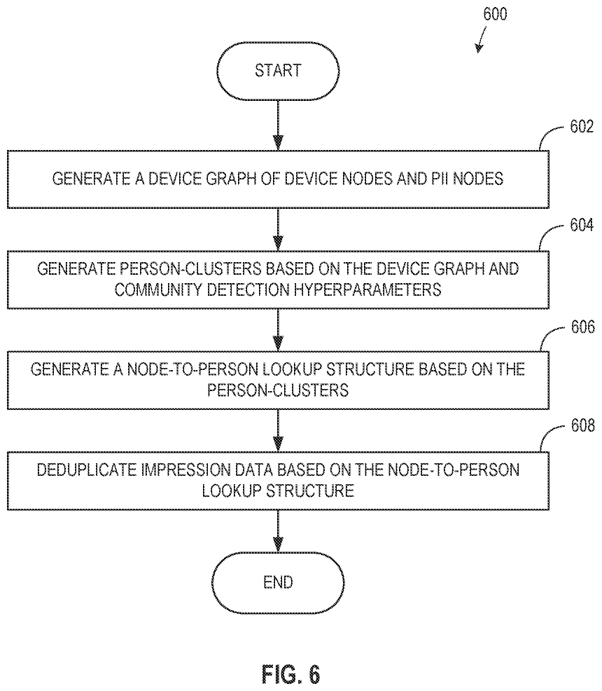

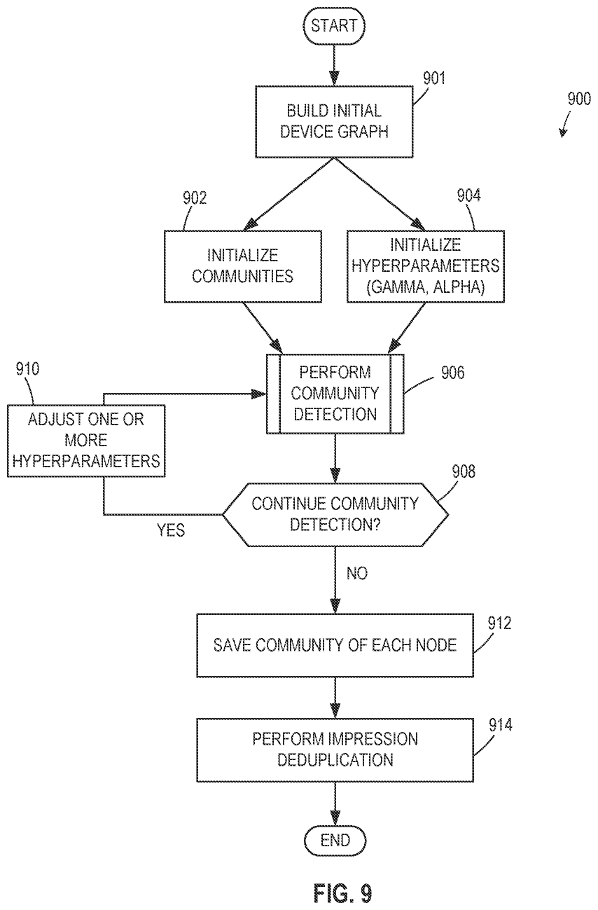

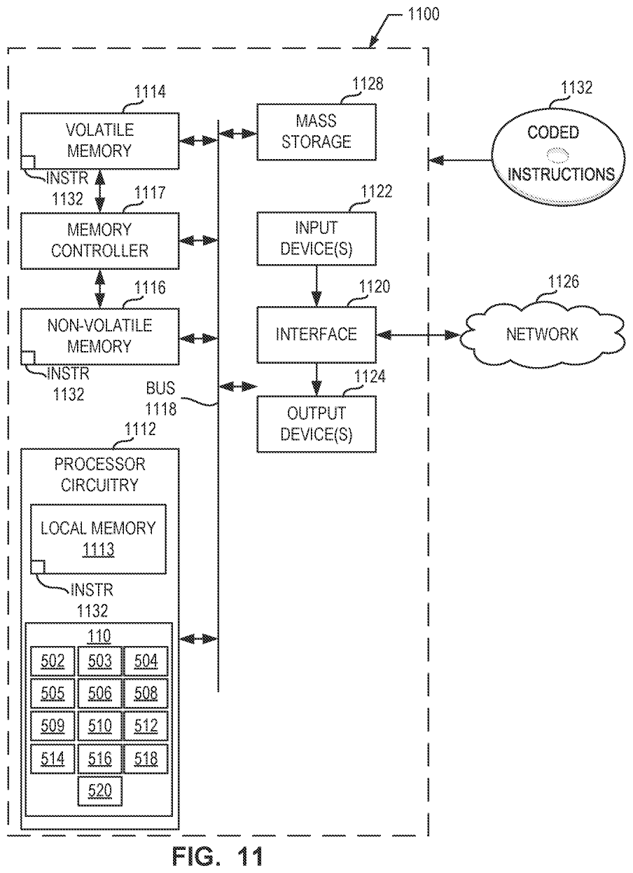

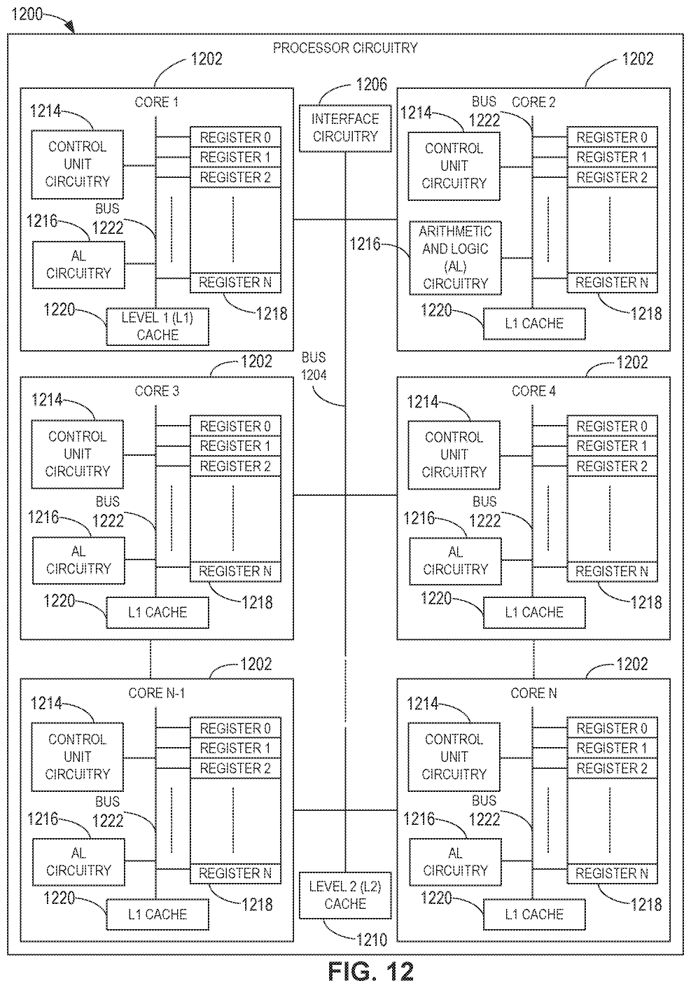

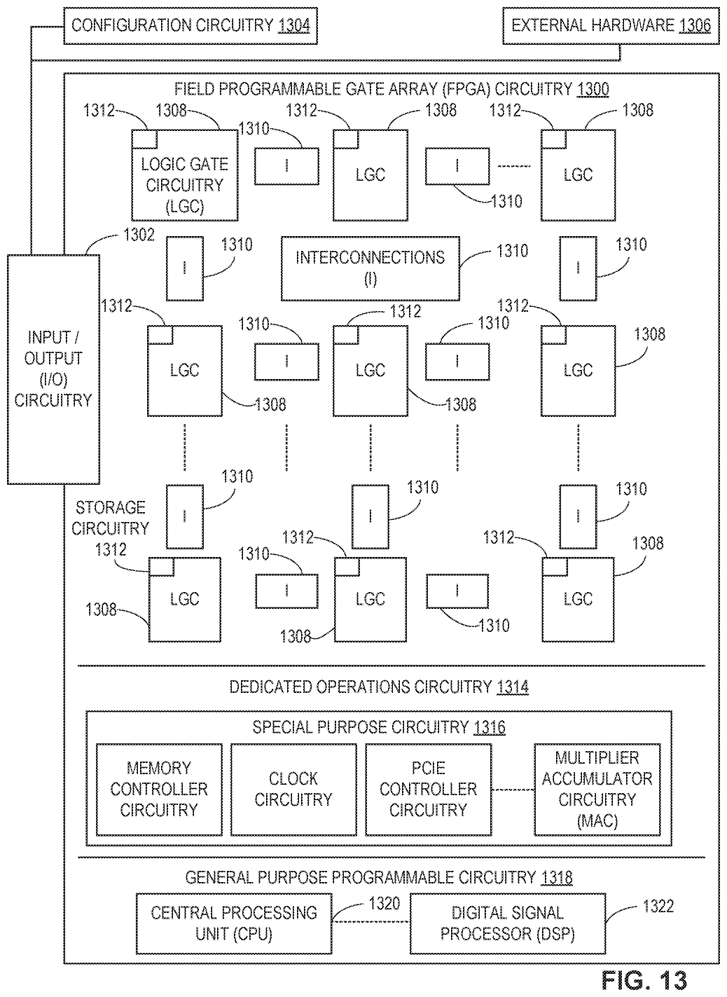

In some examples, the network community monitor 110 includes means for generating a device graph. For example, the means for generating a device graph may be implemented by device graph generator circuitry 504. In some examples, the device graph generator circuitry 504 may be instantiated by processor circuitry such as the example processor circuitry 1112 of FIG. 11. For instance, the device graph generator circuitry 504 may be instantiated by the example general purpose processor circuitry 1200 of FIG. 12 executing machine executable instructions such as that implemented by at least blocks 602 of FIG. 6 and 901 of FIG. 9. In some examples, the device graph generator circuitry 504 may be instantiated by hardware logic circuitry, which may be implemented by an ASIC or the FPGA circuitry 1300 of FIG. 13 structured to perform operations corresponding to the machine readable instructions. Additionally or alternatively, the device graph generator circuitry 504 may be instantiated by any other combination of hardware, software, and/or firmware. For example, the device graph generator circuitry 504 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

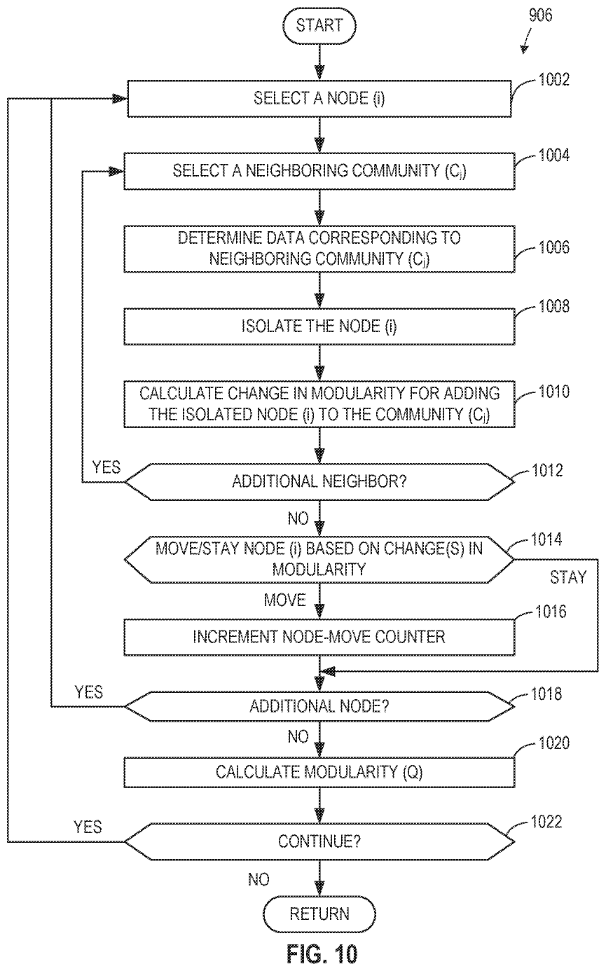

In some examples, the network community monitor 110 includes means for generating person-clusters. For example, the means for generating person-clusters may be implemented by community modifier circuitry 506. In some examples, the community modifier circuitry 506 may be instantiated by processor circuitry such as the example processor circuitry 1112 of FIG. 11. For instance, the device graph generator circuitry 504 may be instantiated by the example general purpose processor circuitry 1200 of FIG. 12 executing machine executable instructions such as that implemented by at least blocks 604 of FIG. 6, 906 of FIG. 9, and 1002, 1004, 1006, 1008, 1010, 1012, 1014, 1016, 1018, 1020, 1022 of FIG. 10. In some examples, the community modifier circuitry 506 may be instantiated by hardware logic circuitry, which may be implemented by an ASIC or the FPGA circuitry 1300 of FIG. 13 structured to perform operations corresponding to the machine readable instructions. Additionally or alternatively, the community modifier circuitry 506 may be instantiated by any other combination of hardware, software, and/or firmware. For example, the community modifier circuitry 506 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the network community monitor 110 includes means for generating a node-to-person lookup structure. For example, the means for generating a node-to-person lookup structure may be implemented by data interface circuitry 518. In some examples, the data interface circuitry 518 may be instantiated by processor circuitry such as the example processor circuitry 1112 of FIG. 11. For instance, the data interface circuitry 518 may be instantiated by the example general purpose processor circuitry 1200 of FIG. 12 executing machine executable instructions such as that implemented by at least blocks 606 of FIG. 6 and 912 of FIG. 9. In some examples, the data interface circuitry 518 may be instantiated by hardware logic circuitry, which may be implemented by an ASIC or the FPGA circuitry 1300 of FIG. 13 structured to perform operations corresponding to the machine readable instructions. Additionally or alternatively, the data interface circuitry 518 may be instantiated by any other combination of hardware, software, and/or firmware. For example, the data interface circuitry 518 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the network community monitor 110 includes means for deduplicating impression data. For example, the means for deduplicating impression data may be implemented by impression deduplicator circuitry 520. In some examples, the impression deduplicator circuitry 520 may be instantiated by processor circuitry such as the example processor circuitry 1112 of FIG. 11. For instance, the impression deduplicator circuitry 520 may be instantiated by the example general purpose processor circuitry 1200 of FIG. 12 executing machine executable instructions such as that implemented by at least blocks 608 of FIG. 6 and 914 of FIG. 9. In some examples, the impression deduplicator circuitry 520 may be instantiated by hardware logic circuitry, which may be implemented by an ASIC or the FPGA circuitry 1300 of FIG. 13 structured to perform operations corresponding to the machine readable instructions. Additionally or alternatively, the impression deduplicator circuitry 520 may be instantiated by any other combination of hardware, software, and/or firmware. For example, the impression deduplicator circuitry 520 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the network community monitor 110 includes means for determining a value of an objective function. For example, the means for determining a value of an objective function may be implemented by objective function calculator circuitry 512. In some examples, the objective function calculator circuitry 512 may be instantiated by processor circuitry such as the example processor circuitry 1112 of FIG. 11. For instance, the objective function calculator circuitry 512 may be instantiated by the example general purpose processor circuitry 1200 of FIG. 12 executing machine executable instructions such as that implemented by at least blocks 1010 and 1020 of FIG. 10. In some examples, the objective function calculator circuitry 512 may be instantiated by hardware logic circuitry, which may be implemented by an ASIC or the FPGA circuitry 1300 of FIG. 13 structured to perform operations corresponding to the machine readable instructions. Additionally or alternatively, the objective function calculator circuitry 512 may be instantiated by any other combination of hardware, software, and/or firmware. For example, the objective function calculator circuitry 512 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the network community monitor 110 includes means for comparing objective function values. For example, the means for comparing objective function values may be implemented by objective function comparator circuitry 516. In some examples, the objective function comparator circuitry 516 may be instantiated by processor circuitry such as the example processor circuitry 1112 of FIG. 11. For instance, the objective function comparator circuitry 516 may be instantiated by the example general purpose processor circuitry 1200 of FIG. 12 executing machine executable instructions such as that implemented by at least blocks 908 of FIG. 9 and 1022 of FIG. 10. In some examples, objective function comparator circuitry 516 may be instantiated by hardware logic circuitry, which may be implemented by an ASIC or the FPGA circuitry 1300 of FIG. 13 structured to perform operations corresponding to the machine readable instructions. Additionally or alternatively, the objective function comparator circuitry 516 may be instantiated by any other combination of hardware, software, and/or firmware. For example, the objective function comparator circuitry 516 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the network community monitor 110 of FIG. 1 is illustrated in FIG. 5, one or more of the elements, processes, and/or devices illustrated in FIG. 5 may be combined, divided, re-arranged, omitted, eliminated, and/or implemented in any other way. Further, the example link data receiver circuitry 502, the example impression data receiver circuitry 503, the example device graph generator circuitry 504, the example community modifier circuitry 506, the example hyperparameter controller circuitry 505, the example data partitioner circuitry 508, the example node selector circuitry 509, the example community selector circuitry 510, the example objective function calculator circuitry 512, the example node community switcher circuitry 514, the example objective function comparator circuitry 516, the example data interface circuitry 518, the example impression deduplicator circuitry 520, and/or, more generally, the example network community monitor 110 of FIG. 5, may be implemented by hardware alone or by hardware in combination with software and/or firmware. Thus, for example, any of the example link data receiver circuitry 502, the example impression data receiver circuitry 503, the example device graph generator circuitry 504, the example community modifier circuitry 506, the example hyperparameter controller circuitry 505, the example data partitioner circuitry 508, the example node selector circuitry 509, the example community selector circuitry 510, the example objective function calculator circuitry 512, the example node community switcher circuitry 514, the example objective function comparator circuitry 516, the example data interface circuitry 518, the example impression deduplicator circuitry 520, and/or, more generally, the example network community monitor 110, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example network community monitor 110 of FIG. 1 may include one or more elements, processes, and/or devices in addition to, or instead of, those illustrated in FIG. 5, and/or may include more than one of any or all of the illustrated elements, processes and devices.

Flowcharts representative of example hardware logic circuitry, machine readable instructions, hardware implemented state machines, and/or any combination thereof for implementing the network community monitor 110 of FIGS. 1, 2, 3, and/or 5 are shown in FIGS. 6, 9, and 10. The machine readable instructions may be one or more executable programs or portion(s) of an executable program for execution by processor circuitry, such as the processor circuitry 1112 shown in the example processor platform 1100 discussed below in connection with FIG. 11 and/or the example processor circuitry discussed below in connection with FIGS. 12 and/or 13. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 6, 9 and 10, many other methods of implementing the example network community monitor 110 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 6, 9, and 10 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium are expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 6 is a flowchart representative of example machine readable instructions and/or example operations 600 that may be executed and/or instantiated by processor circuitry to implement the example network community monitor 110 of FIG. 5. The machine readable instructions and/or the operations 600 of FIG. 6 begin at block 602, at which the example device graph generator circuitry 504 (FIG. 5) generates a device graph (e.g., the device graph 400 of FIG. 4) of device nodes and personally identifiable information (PII) nodes using link data received by the link data receiver circuitry 502. The link data can include any PII that is linked to devices. Example personally identifiable information includes email addresses, cookie IDs, mobile ad IDs (AAID, IDFA), UID 2.0, smart TV IDs, IP addresses (IPv4 & IPv6), ZIP 11, Names, Addresses, and third-party IDs such as Experian ID (PID, LUID), or any combination, variation (e.g., a portion of an email address), or derivation thereof (e.g., a hashed representation of an email address). In some examples, the devices and/or the PII include demographic information. In some examples, the machine readable instructions of block 602 can utilize the device graph generator circuitry 504 to generate a graph visually or to structure and prepare impression data for deduplication.

At block 604, the example community modifier circuitry 506 generates person-clusters based on community detection using community detection hyperparameters. For example, the community modifier circuitry 506 splits graph components (e.g., the device nodes, the PII nodes) into person-clusters. In some examples, the community modifier circuitry 506 implements the hybrid objective function of example Equation 1 or example Equation 3 above to quantify the degree to which the nodes within a community (e.g., the person-cluster 408) interact among themselves relative to interactions with the nodes of other communities to split graph components (e.g., the PII nodes and the device nodes) into person-clusters. However, any other approaches and/or algorithm(s) may additionally or alternatively be used to quantify the degree to which communities (e.g., the person-cluster 408) interact among themselves relative to other communities. For example, a modified version of the hybrid objection function of example Equation 1 or example Equation 3 that enables parallel execution across multiple machines may be used.

At block 606, the example data interface circuitry 518 (FIG. 5) generates a node-to-person lookup structure based on the person-clusters. The node-to-person lookup structure includes records of device nodes and PII nodes and their associated person ID (e.g., person-cluster identity). In some examples, the data interface circuitry 518 saves the node-to-person lookup structure for purposes of result comparison and/or deduplication. At block 608, the example impression deduplicator circuitry 520 (FIG. 5) deduplicates impression data based on the node-to-person lookup structure. For example, the example impression data receiver circuitry 503 (FIG. 5) of the network community monitor 110 may have previously received impression data, each of the impressions corresponding to a component (e.g., a device node, a PII node) of the device graph. The example impression deduplicator circuitry 520 can utilize the node-to-person lookup structure to determine a person ID (e.g., a person-cluster identity) associated with each of the impressions. If the example impression deduplicator circuitry 520 identifies any duplicated impressions (e.g., two or more impressions for the same media associated with the same person ID), the impression deduplicator circuitry 520 can deduplicate the two or more impressions to be represented as a single impression. The deduplicated impressions can be used to accurately determine the unique audience size of the media. The example instructions of FIG. 6 end.

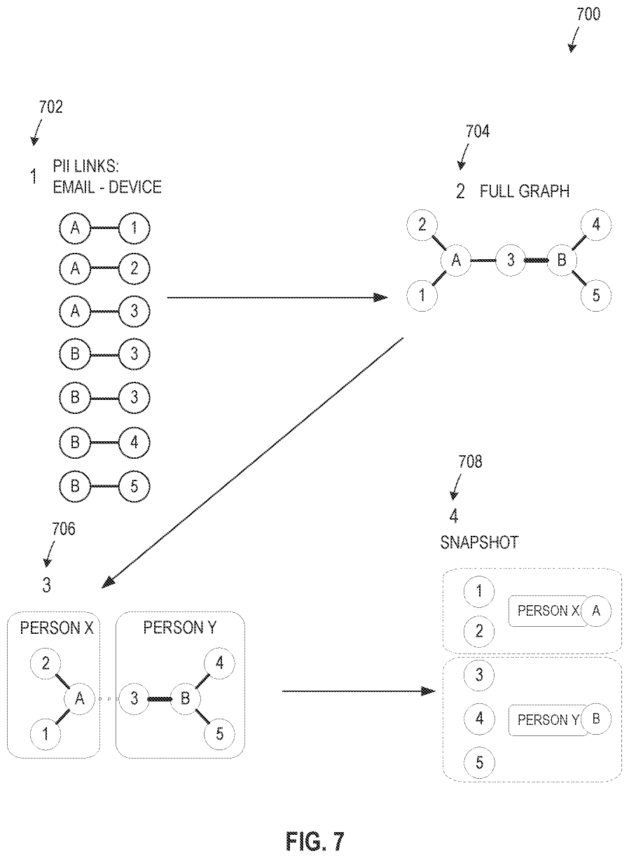

FIG. 7 illustrates the example node-to-person lookup structure generation process of the example computer readable instructions of blocks 602, 604 and 606 of FIG. 6. At example operation 1 702, the links (e.g., PII-to-device links) are received by the link data receiver circuitry 502 (FIG. 5) as email addresses linked to devices with which the email addresses have been observed to interact.

At example operation 2 704, a full device graph is built from the link data using the computer readable instructions of block 602 (FIG. 6), executed by device graph generator circuitry 504. In the device graph of example operation 2 704, device nodes are represented by numbers 1-5 and email address nodes are represented by letters A and B. The link between the device three node and the email address B node is weighted (e.g., represented by a thicker line) to represent the increased quantity (e.g., 2) of interactions (e.g., links) recorded between device three and email address B compared to the frequency of interactions between each of the other devices and email addresses. In some examples, the weighting of a link between a device and an email address (or other person ID) may be based on frequency and/or quantity of interactions.

In example operation 3 706, the devices that most frequently interact with email address A or email address B are split into person-clusters using the computer readable instructions of block 604 (FIG. 6), executed by the community modifier circuitry 506 (FIG. 5). In example operation 3 706, users are represented as Person X and Person Y. In this example, devices one and two most frequently interact with email address A, and devices three, four, and five most frequently interact with email address B forming the two person-clusters of Person X and Person Y. While device 3 is connected to both email address A and email address B, email address B and device 3 are more strongly associated, as indicated by the thicker line between email address B and device 3 in operation 2. As expected, when the example device graph of operation 704 is split into person-clusters in operation 3 706, device 3 is associated with Person Y and no longer with Person X.

In example operation 4 708, a snapshot (e.g., a snapshot lookup structure, a node-to-person lookup structure, a node-to-person assignments structure, etc.) is created that includes a lookup of person IDs and one or more devices and one or more email addresses associated with the person ID, using the computer readable instructions of block 606 (FIG. 6), executed by the data interface circuitry 518 (FIG. 5). In some examples, an impression report can also be prepared using snapshot information.

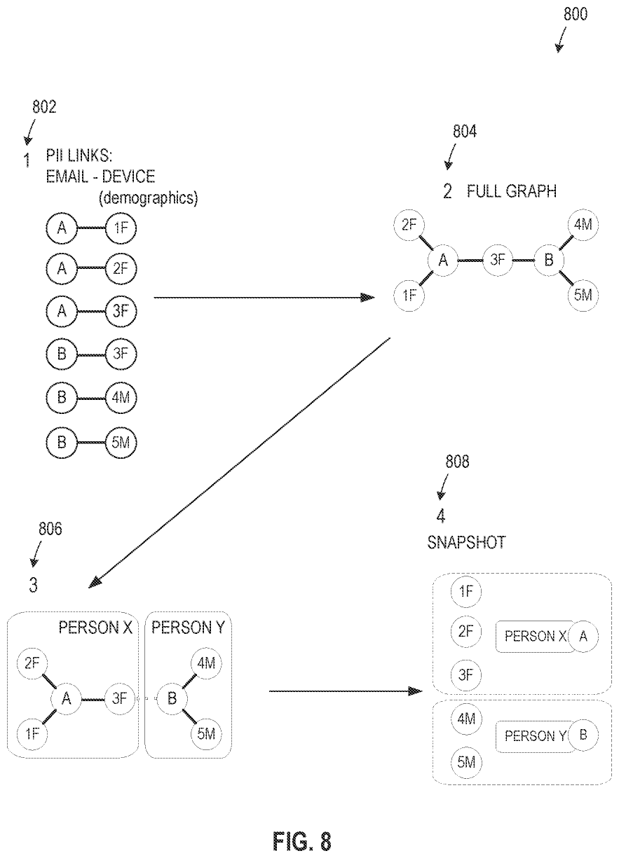

FIG. 8 illustrates a second implementation of the example node-to-person lookup structure generation process of the example computer readable instructions of blocks 602, 604, and 606 of FIG. 6. In example operation 1 802, the PII-to-device links are received by the link data receiver circuitry 502 (FIG. 5) as email addresses linked to devices with which the email addresses have been observed to interact. In the example of FIG. 8, the PII-to-device links include demographic information associated with each of the devices. For example, devices one, two, and three are associated with female users (e.g., represented by “F”) and devices 4 and 5 are associated with male users (e.g., represented by “M”). Although demographic information in example FIG. 8 is shown as the sex of a person, the example of FIG. 8 may additionally or alternatively include one or more other types of demographic information such as age, ethnicity, race, physical address information, physical location/region, household income, marital status, etc.

In example operation 2 804, a full device graph is built from the link data using the computer readable instructions of block 602 (FIG. 6), executed by device graph generator circuitry 504 (FIG. 5). In the example device graph of operation 2 804, device nodes are represented by numbers 1-5 followed by a letter F or a letter M corresponding to a female user or a male user, and email address nodes are represented by letters A and B.

In example operation 3 806, the devices that most frequently interact with email address A or email address B and have the most homogeneity within the clusters are split into person-clusters using the computer readable instructions of block 604 (FIG. 6), executed by the community modifier circuitry 506 (FIG. 5). In the example operation 3 806, users are represented as Person X and Person Y. In this example, devices one, two, and three form the person-cluster of Person X, while devices three and four form the person-cluster of Person Y. In the example of FIG. 8, devices one and two most frequently interact with email address A, and devices four and five most frequently interact with email address B. Device three interacts with email address A with the same frequency as device three interacts with email address B. However, device three joining the Person X cluster results in more homogeneity within the person-clusters because devices one, two, and three are all associated with female users. When the example device graph of operation 2 804 is split into person-clusters in operation 3 806, device 3 is associated with Person X and no longer with Person Y.

In example operation 4 808, a snapshot (e.g., a node-to-person lookup structure) is created that includes a lookup of person IDs and one or more devices and one or more email addresses associated with the person IDs, using the computer readable instructions of block 608 (FIG. 6), executed by the data interface circuitry 518 (FIG. 5). In some examples, an impression report can also be prepared using snapshot information.

FIG. 9 is a flowchart representative of example machine readable instructions and/or example operations 900 that may be executed and/or instantiated by processor circuitry to implement the example network community monitor 110 of FIG. 5 to deduplicate impression data. The example machine readable instructions and/or the operations 900 of FIG. 9 begin at block 901, at which the example device graph generator circuitry 504 builds an initial device graph. For example, the initial device graph can include linked graph components (e.g., PII nodes, device nodes). In some examples, the link data can be received from a single database proprietor (e.g., the database proprietor 107 of FIG. 1) by the example link data receiver circuitry 502. In other examples, the link data can be received from a plurality of database proprietors and aggregated by the example device graph generator circuitry 504 to form a single, aggregated initial device graph. At block 902, the example data partitioner circuitry 508 (FIG. 5) initializes communities in the device graph as communities defined by respective single devices. In some examples, devices can be linked to many different devices via PII or can be linked to one other device only.

At block 904, the example hyperparameter controller circuitry 505 (FIG. 5) initializes the hyperparameters of a hybrid objective function. For example, the hyperparameter controller circuitry 505 sets a value for each of the hyperparameters gamma and alpha of example Equation 1 or example Equation 3 above. In some examples, the hyperparameter controller circuitry 505 initializes the hyperparameters based on previously used hyperparameters for a similar device graph. In other examples, the hyperparameter controller circuitry 505 can use a grid search technique to initialize the hyperparameters. For example, a set number (e.g., three) of values for each hyperparameter may be evaluated over the course of a number of iterations (e.g., nine iterations) of community detection. In other examples, the hyperparameter controller circuitry 505 can initialize the hyperparameters randomly, at a minimum value, at a maximum possible value, or using any other method.

At block 906, the example community modifier circuitry 506 (FIG. 5) performs community detection. Example instructions that may be used to implement the community detection of block 906 are discussed below in conjunction with FIG. 10. As a result of the operations of block 906, the example community modifier circuitry 506 splits graph components into person-clusters and the example data interface circuitry 518 saves the resulting person-clusters and properties of the resulting device graph (e.g., a modularity value of the device graph, an average person-cluster size, a person-cluster size variance, etc.). At block 908, the example objective function comparator circuitry 516 (FIG. 5) determines whether or not to continue community detection. For the example of using a grid search technique to initialize the hyperparameters at block 904, the example objective function comparator circuitry 516 can determine if additional iterations are needed to complete the grid search. In other examples, the objective function comparator circuitry 516 determines if convergence of the modularity value of the device graph has occurred. For example, the objective function comparator circuitry 516 can compare the modularity of the device graph to a previously calculated modularity value of a previous device graph to determine if the modularity of the device graph has reached a plateau (e.g., no increase, minimal increase from a previous iteration, etc.). Additionally or alternatively, the objective function comparator circuitry 516 can determine if convergence has occurred by evaluating a number of nodes that have switched communities in the latest community detection iteration. If the number of nodes that have switched communities in the latest community detection iteration is below a threshold, the objective function comparator circuitry 516 can determine that convergence has occurred. If the example objective function comparator circuitry 516 determines that convergence has occurred, the objective function comparator circuitry 516 decides not to continue community detection (block 908: NO). If the example objective function comparator circuitry 516 determines that convergence has not occurred, the objective function comparator circuitry 516 decides to continue community detection (block 908: YES). If the example objective function comparator circuitry 516 determines community detection should be continued (block 908: YES), the process continues at block 910, where the hyperparameter controller circuitry 505 adjusts one or more of the hyperparameters. For the example of using a grid search technique to initialize the hyperparameters at block 904, the example hyperparameter controller circuitry 505 can adjust the one or more hyperparameters by setting one or more of the hyperparameters to a different value defined by the grid search. In another example, the one or more hyperparameters are adjusted based on the results of the community detection process. For example, there may be a desired person-cluster size and/or person-cluster size variance for the device graph. The example hyperparameter controller circuitry 505 can increase or decrease the hyperparameters (e.g., gamma, alpha) in response to the average person-cluster size and/or person-cluster size variance of the resulting device graph of the latest community detection iteration in order to tune the hybrid objective function. For example, if the average person-cluster size of the resulting device graph is larger than desired, the hyperparameter gamma can be decreased to discourage person-cluster growth in a subsequent community detection iteration. In another example, if the average person-cluster size of the resulting device graph is smaller than desired, the hyperparameter gamma can be increased to encourage person-cluster growth in a subsequent community detection iteration. In another example, if the person-cluster size variance of the resulting device graph is smaller than desired, the hyperparameter alpha can be increased to encourage person-cluster size variance. In another example, if the person-cluster size variance of the resulting device graph is larger than desired, the hyperparameter alpha can be decreased to discourage person-cluster size variance.

If the example objective function comparator circuitry 516 determines community detection should not be continued (block 908: NO), control advances to block 912 at which the community detection algorithm is stopped, and the communities of each node are saved by the data interface circuitry 518 (FIG. 5). In some examples, the data interface circuitry 518 creates a snapshot (e.g., a snapshot lookup structure, a node-to-person lookup structure, a node-to-person assignments structure, etc.) of person IDs and their associated devices and/or PII. In other examples, the data interface circuitry 518 causes the device graph generator circuitry 504 to build a new device graph from the snapshot. In some examples, data interface circuitry 518 saves the snapshot only temporarily.

At block 914, the example impression deduplicator circuitry 520 deduplicates impression data based on the snapshot (e.g., a snapshot lookup structure, a node-to-person lookup structure, a node-to-person assignments structure, etc.). For example, the impression data receiver circuitry 503 (FIG. 5) of the network community monitor 110 may have previously received impression data, each of the impressions corresponding to a component (e.g., a device node, a PII node) of the device graph. The impression deduplicator circuitry 520 can utilize the snapshot to determine a person ID (e.g., a person-cluster identity) associated with each of the impressions. If the example impression deduplicator circuitry 520 identifies any duplicated impressions (e.g., two or more impressions for the same media associated with the same person ID), the impression deduplicator circuitry 520 can deduplicate the two or more impressions to be represented as a single impression. The deduplicated impressions can be used to accurately determine the unique audience size of the media. The example instructions of FIG. 9 end.

FIG. 10 is a flowchart representative of example machine readable instructions and/or example operations 906 (FIG. 9) that may be executed and/or instantiated by processor circuitry to perform community detection. The example machine readable instructions and/or the operations 906 of FIG. 10 begin at block 1002, at which the node selector circuitry 509 (FIG. 5) selects a node (i) to modify. For example, the node selector circuitry 509 can select a first listed node. In other examples, the node selector circuitry 509 determines which node to select based on which nodes have already been selected and/or those that can be used to best simplify the device graph. At block 1004, the example community selector circuitry 510 (FIG. 5) selects a community (Cⱼ) that is a neighbor (e.g., directly connected) to the node (i) selected at block 1002. At block 1006, the example objective function calculator circuitry 512 (FIG. 5) determines data corresponding to the neighboring community (Cⱼ). For example, the objective function calculator circuitry 512 determines a degree (e.g., a number of internal connections, a sum of the degree of each of the nodes within a community) of the neighboring community (k_{c}_{ⱼ}), a number of nodes of the neighboring community (n_{c}_{ⱼ}), and a sum of edges between node (i) and the neighboring community (k_{i,c}_{ⱼ}) based on the device graph.

At block 1008, the example node community switcher circuitry 514 (FIG. 5) isolates the node (i). For example, the node community switcher circuitry 514 removes the node (i) from the community (Cᵢ) such that the node (i) does not belong to any community. At block 1010, the example objective function calculator circuitry 512 calculates a change in modularity for adding the isolated node (i) to the neighboring community (Cⱼ). For example, the objective function calculator circuitry 512 can use example Equation 4 above to determine the change (e.g., increase or decrease) in the modularity of the device graph if isolated node (i) is added to the neighboring community (Cⱼ). In the example where the device graph includes demographic information associated with the PII and/or devices of the device graph, the example objective function calculator circuitry 512 can use example Equation 5 above to determine the change (e.g., increase or decrease) in the modularity of the device graph if isolated node (i) is added to the neighboring community (Cⱼ) while accounting for node homogeneity of the clusters.

At block 1012, the example community selector circuitry 510 determines if the original community (Cᵢ) of the node (i) has any additional neighboring communities which have not yet been selected and evaluated. If the example community selector circuitry 510 determines at block 1012 there is at least one additional neighboring community, control returns to block 1004 at which the community selector circuitry 510 selects another neighboring community to process next. If the example community selector circuitry 510 determines at block 1012 that no neighboring communities of the original community (Cᵢ) of the node (i) remain to be selected and evaluated, control advances to block 1014. At block 1014, the example node community switcher circuitry 514 (FIG. 5) determines whether the node (i) should stay within the original community (Cᵢ) or switch to one of the neighboring communities (Cⱼ). For example, the node community switcher circuitry 514 compares the one or more changes in modularity for adding the isolated node (i) to the one or more neighboring communities calculated at each iteration of block 1010 for the node (i). If each of the one or more changes in modularity for adding the isolated node (i) to the one or more neighboring communities is less than zero, the example node community switcher circuitry 514 determines that the node (i) should stay within the original community (Cᵢ) (block 1014: STAY). If the example node community switcher circuitry 514 determines that the node (i) should stay within the original community (Cᵢ), control advances to block 1018.

If one or more of the changes in modularity for adding the isolated node (i) to the one or more neighboring communities is greater than zero, the example node community switcher circuitry 514 determines that the node (i) should move to the neighboring community that results in the largest increase in modularity. If the example node community switcher circuitry 514 determines that the node (i) should move to a neighboring community (block 1014: MOVE), the node community switcher circuitry 514 moves the node (e.g., adjusts a community of the node) and control advances to block 1016. At block 1016, the example node community switcher circuitry 514 increments a node-move counter by one. For example, the node community switcher circuitry 514 can use a node-move counter to keep a record that tracks a total number of nodes moved during a given iteration of the community detection process. At block 1018, the example node community switcher circuitry 514 increments the node-move counter based on the decision to move the node made at block 1014.

At block 1018, the example node selector circuitry 509 determines if one or more additional nodes of the device graph have not yet been selected and evaluated. If the example node selector circuitry 509 determines at block 1016 there is one or more additional nodes remaining to be selected and evaluated, control returns to block 1002, and one of the remaining nodes is selected. If the example node selector circuitry 509 determines at block 1016 that no nodes of the device graph remain to be selected and evaluated, control advances to block 1020 at which the objective function calculator circuitry 512 (FIG. 5) calculates a modularity value for the resulting device graph. For example, the objective function calculator circuitry 512 can use the hybrid objective function of example Equation 1 above to calculate the modularity of the resulting device graph. In the example where the device graph includes demographic information associated with the PII and/or devices of the device graph, the objective function calculator circuitry 512 can use the hybrid objective function of example Equation 3 above to calculate the modularity of the resulting device graph while accounting for node homogeneity of the clusters.

At block 1022, the example objective function comparator circuitry 516 (FIG. 5) determines whether to continue community detection. For example, the objective function comparator circuitry 516 can determine if convergence of the modularity value of the device graph has occurred. For example, the objective function comparator circuitry 516 can compare the modularity of the device graph to a previously calculated modularity value of a previous device graph to determine if the modularity of the device graph has reached a plateau (e.g., no increase, minimal increase from a previous iteration, etc.). Additionally or alternatively, the example objective function comparator circuitry 516 can determine if convergence has occurred by assessing the value of the node-move counter (e.g., the node-move counter incremented at block 1016) which indicates a number of nodes that have switched communities in the latest community detection iteration. If the value of the node-move counter indicates that a number of nodes that have switched communities in the latest community detection iteration is below a threshold, the example objective function comparator circuitry 516 can determine that convergence has occurred. In some examples, a value for the threshold is selected so that additional iterations of community detection are not performed if only a small number of nodes switch in an iteration so as to save computing resources. If the example objective function comparator circuitry 516 determines at block 1022 that convergence has occurred, the objective function comparator circuitry 516 decides not to continue community detection (block 1022: NO). If the example objective function comparator circuitry 516 determines at block 1022 that convergence has not occurred, the objective function comparator circuitry 516 decides to continue community detection (block 1022: YES). In other examples, the objective function comparator circuitry 516 can determine at block 1022 whether to continue community detection based one or more other factors (e.g., a set number of iterations, etc.).

If the example objective function comparator circuitry 516 determines at block 1022 that community detection should be continued (block 1020: YES), control returns to block 1002, at which the node selector circuitry 509 selects a node for evaluation. If the example objective function comparator circuitry 516 determines at block 1022 community detection should not be continued (block 1020: NO), the example instructions of FIG. 10 end.

FIG. 11 is a block diagram of an example processor platform 1100 structured to execute and/or instantiate the machine readable instructions and/or the operations of FIGS. 6, 9 and 10 to implement the network community monitor 110 of FIG. 5. The processor platform 1100 can be, for example, a server, a personal computer, a workstation, a self-learning machine (e.g., a neural network), or any other type of computing device.

The processor platform 1100 of the illustrated example includes processor circuitry 1112. The processor circuitry 1112 of the illustrated example is hardware. For example, the processor circuitry 1112 can be implemented by one or more integrated circuits, logic circuits, FPGAs, microprocessors, CPUs, GPUs, DSPs, and/or microcontrollers from any desired family or manufacturer. The processor circuitry 1112 may be implemented by one or more semiconductor based (e.g., silicon based) devices. In this example, the processor circuitry 1112 implements the link data receiver circuitry 502, the impression data receiver circuitry 503, the device graph generator circuitry 504, the community modifier circuitry 506, the hyperparameter controller circuitry 505, the data partitioner circuitry 508, the node selector circuitry 509, the community selector circuitry 510, the objective function calculator circuitry 512, the node community switcher circuitry 514, the objective function comparator circuitry 516, the data interface circuitry 518, the impression deduplicator circuitry 520, and the network community monitor 110.

The processor circuitry 1112 of the illustrated example includes a local memory 1113 (e.g., a cache, registers, etc.). The processor circuitry 1112 of the illustrated example is in communication with a main memory including a volatile memory 1114 and a non-volatile memory 1116 by a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1116 may be implemented by flash memory and/or any other desired type of memory device. Access to the main memory 1114, 1116 of the illustrated example is controlled by a memory controller 1117.

The processor platform 1100 of the illustrated example also includes interface circuitry 1120. The interface circuitry 1120 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1122 are connected to the interface circuitry 1120. The input device(s) 1122 permit(s) a user to enter data and/or commands into the processor circuitry 1112. The input device(s) 1122 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1124 are also connected to the interface circuitry 1120 of the illustrated example. The output device(s) 1124 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1120 of the illustrated example, thus, typically includes a graphics driver card, a graphics driver chip, and/or graphics processor circuitry such as a GPU.

The interface circuitry 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1126. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1100 of the illustrated example also includes one or more mass storage devices 1128 to store software and/or data. Examples of such mass storage devices 1128 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine executable instructions 1132, which may be implemented by the machine readable instructions of FIGS. 6, 9 and 10, may be stored in the mass storage device 1128, in the volatile memory 1114, in the non-volatile memory 1116, and/or on a removable non-transitory computer readable storage medium such as a CD or DVD.

FIG. 12 is a block diagram of an example implementation of the processor circuitry 1112 of FIG. 11. In this example, the processor circuitry 1112 of FIG. 11 is implemented by a general purpose microprocessor 1200. The general purpose microprocessor circuitry 1200 executes some or all of the machine readable instructions of the flowcharts of FIGS. 6, 9 and 10 to effectively instantiate the circuitry of FIG. 5 as logic circuits to perform the operations corresponding to those machine readable instructions. In some such examples, the circuitry of FIG. 5 is instantiated by the hardware circuits of the microprocessor 1200 in combination with the instructions. For example, the microprocessor 1200 may implement multi-core hardware circuitry such as a CPU, a DSP, a GPU, an XPU, etc. Although it may include any number of example cores 1202 (e.g., 1 core), the microprocessor 1200 of this example is a multi-core semiconductor device including N cores. The cores 1202 of the microprocessor 1200 may operate independently or may cooperate to execute machine readable instructions. For example, machine code corresponding to a firmware program, an embedded software program, or a software program may be executed by one of the cores 1202 or may be executed by multiple ones of the cores 1202 at the same or different times. In some examples, the machine code corresponding to the firmware program, the embedded software program, or the software program is split into threads and executed in parallel by two or more of the cores 1202. The software program may correspond to a portion or all of the machine readable instructions and/or operations represented by the flowcharts of FIGS. 6, 9, and 10.

The cores 1202 may communicate by a first example bus 1204. In some examples, the first bus 1204 may implement a communication bus to effectuate communication associated with one(s) of the cores 1202. For example, the first bus 1204 may implement at least one of an Inter-Integrated Circuit (I2C) bus, a Serial Peripheral Interface (SPI) bus, a PCI bus, or a PCIe bus. Additionally or alternatively, the first bus 1204 may implement any other type of computing or electrical bus. The cores 1202 may obtain data, instructions, and/or signals from one or more external devices by example interface circuitry 1206. The cores 1202 may output data, instructions, and/or signals to the one or more external devices by the interface circuitry 1206. Although the cores 1202 of this example include example local memory 1220 (e.g., Level 1 (L1) cache that may be split into an L1 data cache and an L1 instruction cache), the microprocessor 1200 also includes example shared memory 1210 that may be shared by the cores (e.g., Level 2 (L2_cache)) for high-speed access to data and/or instructions. Data and/or instructions may be transferred (e.g., shared) by writing to and/or reading from the shared memory 1210. The local memory 1220 of each of the cores 1202 and the shared memory 1210 may be part of a hierarchy of storage devices including multiple levels of cache memory and the main memory (e.g., the main memory 1114, 1116 of FIG. 11). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1202 may be referred to as a CPU, DSP, GPU, etc., or any other type of hardware circuitry. Each core 1202 includes control unit circuitry 1214, arithmetic and logic (AL) circuitry (sometimes referred to as an ALU) 1216, a plurality of registers 1218, the L1 cache 1220, and a second example bus 1222. Other structures may be present. For example, each core 1202 may include vector unit circuitry, single instruction multiple data (SIMD) unit circuitry, load/store unit (LSU) circuitry, branch/jump unit circuitry, floating-point unit (FPU) circuitry, etc. The control unit circuitry 1214 includes semiconductor-based circuits structured to control (e.g., coordinate) data movement within the corresponding core 1202. The AL circuitry 1216 includes semiconductor-based circuits structured to perform one or more mathematic and/or logic operations on the data within the corresponding core 1202. The AL circuitry 1216 of some examples performs integer based operations. In other examples, the AL circuitry 1216 also performs floating point operations. In yet other examples, the AL circuitry 1216 may include first AL circuitry that performs integer based operations and second AL circuitry that performs floating point operations. In some examples, the AL circuitry 1216 may be referred to as an Arithmetic Logic Unit (ALU). The registers 1218 are semiconductor-based structures to store data and/or instructions such as results of one or more of the operations performed by the AL circuitry 1216 of the corresponding core 1202. For example, the registers 1218 may include vector register(s), SIMD register(s), general purpose register(s), flag register(s), segment register(s), machine specific register(s), instruction pointer register(s), control register(s), debug register(s), memory management register(s), machine check register(s), etc. The registers 1218 may be arranged in a bank as shown in FIG. 12. Alternatively, the registers 1218 may be organized in any other arrangement, format, or structure including distributed throughout the core 1202 to shorten access time. The second bus 1222 may implement at least one of an I2C bus, a SPI bus, a PCI bus, or a PCIe bus

Each core 1202 and/or, more generally, the microprocessor 1200 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1200 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 13 is a block diagram of another example implementation of the processor circuitry 1112 of FIG. 11. In this example, the processor circuitry 1112 is implemented by FPGA circuitry 1300. The FPGA circuitry 1300 can be used, for example, to perform operations that could otherwise be performed by the example microprocessor 1200 of FIG. 12 executing corresponding machine readable instructions. However, once configured, the FPGA circuitry 1300 instantiates the machine readable instructions in hardware and, thus, can often execute the operations faster than they could be performed by a general purpose microprocessor executing the corresponding software.

More specifically, in contrast to the microprocessor 1200 of FIG. 12 described above (which is a general purpose device that may be programmed to execute some or all of the machine readable instructions represented by the flowcharts of FIGS. 6, 9 and 10 but whose interconnections and logic circuitry are fixed once fabricated), the FPGA circuitry 1300 of the example of FIG. 13 includes interconnections and logic circuitry that may be configured and/or interconnected in different ways after fabrication to instantiate, for example, some or all of the machine readable instructions represented by the flowcharts of FIGS. 6, 9, and 10. In particular, the FPGA 1300 may be thought of as an array of logic gates, interconnections, and switches. The switches can be programmed to change how the logic gates are interconnected by the interconnections, effectively forming one or more dedicated logic circuits (unless and until the FPGA circuitry 1300 is reprogrammed). The configured logic circuits enable the logic gates to cooperate in different ways to perform different operations on data received by input circuitry. Those operations may correspond to some or all of the software represented by the flowcharts of FIGS. 6, 9, and 10. As such, the FPGA circuitry 1300 may be structured to effectively instantiate some or all of the machine readable instructions of the flowcharts of FIGS. 6, 9, and 10 as dedicated logic circuits to perform the operations corresponding to those software instructions in a dedicated manner analogous to an ASIC. Therefore, the FPGA circuitry 1300 may perform the operations corresponding to the some or all of the machine readable instructions of FIGS. 6, 9, and 10 faster than the general purpose microprocessor can execute the same.

In the example of FIG. 13, the FPGA circuitry 1300 is structured to be programmed (and/or reprogrammed one or more times) by an end user by a hardware description language (HDL) such as Verilog. The FPGA circuitry 1300 of FIG. 13, includes example input/output (I/O) circuitry 1302 to obtain and/or output data to/from example configuration circuitry 1304 and/or external hardware (e.g., external hardware circuitry) 1306. For example, the configuration circuitry 1304 may implement interface circuitry that may obtain machine readable instructions to configure the FPGA circuitry 1300, or portion(s) thereof. In some such examples, the configuration circuitry 1304 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1306 may implement the microprocessor 1200 of FIG. 12. The FPGA circuitry 1300 also includes an array of example logic gate circuitry 1308, a plurality of example configurable interconnections 1310, and example storage circuitry 1312. The logic gate circuitry 1308 and interconnections 1310 are configurable to instantiate one or more operations that may correspond to at least some of the machine readable instructions of FIGS. 6, 9, and 10 and/or other desired operations. The logic gate circuitry 1308 shown in FIG. 13 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1308 to enable configuration of the electrical structures and/or the logic gates to form circuits to perform desired operations. The logic gate circuitry 1308 may include other electrical structures such as look-up tables (LUTs), registers (e.g., flip-flops or latches), multiplexers, etc.

The interconnections 1310 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1308 to program desired logic circuits.

The storage circuitry 1312 of the illustrated example is structured to store result(s) of the one or more of the operations performed by corresponding logic gates. The storage circuitry 1312 may be implemented by registers or the like. In the illustrated example, the storage circuitry 1312 is distributed amongst the logic gate circuitry 1308 to facilitate access and increase execution speed.

The example FPGA circuitry 1300 of FIG. 13 also includes example Dedicated Operations Circuitry 1314. In this example, the Dedicated Operations Circuitry 1314 includes special purpose circuitry 1316 that may be invoked to implement commonly used functions to avoid the need to program those functions in the field. Examples of such special purpose circuitry 1316 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1300 may also include example general purpose programmable circuitry 1318 such as an example CPU 1320 and/or an example DSP 1322. Other general purpose programmable circuitry 1318 may additionally or alternatively be present such as a GPU, an XPU, etc., that can be programmed to perform other operations.

Although FIGS. 12 and 12 illustrate two example implementations of the processor circuitry 1112 of FIG. 11, many other approaches are contemplated. For example, as mentioned above, modern FPGA circuitry may include an on-board CPU, such as one or more of the example CPU 1320 of FIG. 13. Therefore, the processor circuitry 1112 of FIG. 11 may additionally be implemented by combining the example microprocessor 1200 of FIG. 12 and the example FPGA circuitry 1300 of FIG. 13. In some such hybrid examples, a first portion of the machine readable instructions represented by the flowcharts of FIGS. 6, 9 and 10 may be executed by one or more of the cores 1202 of FIG. 12, a second portion of the machine readable instructions represented by the flowcharts of FIGS. 6, 9, and 10 may be executed by the FPGA circuitry 1300 of FIG. 13, and/or a third portion of the machine readable instructions represented by the flowcharts of FIGS. 6, 9, and 10 may be executed by an ASIC. It should be understood that some or all of the circuitry of FIG. 5 may, thus, be instantiated at the same or different times. Some or all of the circuitry may be instantiated, for example, in one or more threads executing concurrently and/or in series. Moreover, in some examples, some or all of the circuitry of FIG. 5 may be implemented within one or more virtual machines and/or containers executing on the microprocessor.

In some examples, the processor circuitry 1112 of FIG. 11 may be in one or more packages. For example, the processor circuitry 1200 of FIG. 12 and/or the FPGA circuitry 1300 of FIG. 13 may be in one or more packages. In some examples, an XPU may be implemented by the processor circuitry 1112 of FIG. 11, which may be in one or more packages. For example, the XPU may include a CPU in one package, a DSP in another package, a GPU in yet another package, and an FPGA in still yet another package.

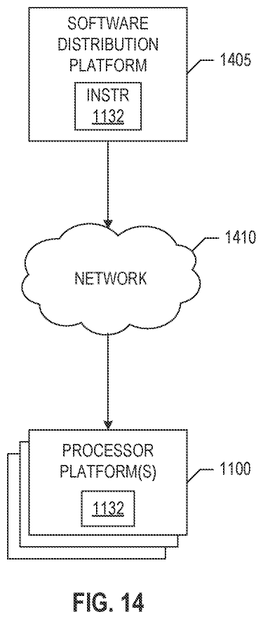

A block diagram illustrating an example software distribution platform 1405 to distribute software such as the example machine readable instructions 1132 of FIG. 11 to hardware devices owned and/or operated by third parties is illustrated in FIG. 14. The example software distribution platform 1405 may be implemented by any computer server, data facility, cloud service, etc., capable of storing and transmitting software to other computing devices. The third parties may be customers of the entity owning and/or operating the software distribution platform 1405. For example, the entity that owns and/or operates the software distribution platform 1405 may be a developer, a seller, and/or a licensor of software such as the example machine readable instructions 1132 of FIG. 11. The third parties may be consumers, users, retailers, OEMs, etc., who purchase and/or license the software for use and/or re-sale and/or sub-licensing. In the illustrated example, the software distribution platform 1405 includes one or more servers and one or more storage devices. The storage devices store the machine readable instructions 1132, which may correspond to the example machine readable instructions 600, 900, 906 of FIGS. 6, 9, and 10, as described above. The one or more servers of the example software distribution platform 1405 are in communication with a network 1410, which may correspond to any one or more of the Internet and/or any of the example networks 106 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1132 from the software distribution platform 1405. For example, the software, which may correspond to the example machine readable instructions 600, 900, 906 of FIGS. 6, 9, and 10, may be downloaded to the example processor platform 1100, which is to execute the machine readable instructions 1132 to implement the network community monitor 110. In some example, one or more servers of the software distribution platform 1405 periodically offer, transmit, and/or force updates to the software (e.g., the example machine readable instructions 1132 of FIG. 11) to ensure improvements, patches, updates, etc., are distributed and applied to the software at the end user devices.

From the foregoing, it will be appreciated that example systems, methods, apparatus, and articles of manufacture have been disclosed that identify users via community detection. The disclosed systems, methods, apparatus, and articles of manufacture allow for user identification of disparate electronic devices and therefore enable deduplication of impressions from the device level to the person level. To that end, examples disclosed herein improve the efficiency of using a computing device by reducing the storage of duplicate media monitoring records. Such reductions in monitoring records require less computing resources to store, process, and transmit. As a result, less memory resources are required, less compute resources are required, and less communication resources are required, thereby freeing up such computing resources for other tasks. Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture for user identification via community detection and deduplication are disclosed herein. Further examples and combinations thereof include the following:

Example 1 includes an apparatus comprising at least one memory, instructions, and processor circuitry to execute the instructions to generate a device graph, the device graph to represent links between ones of personally identifiable information nodes and ones of device nodes, generate person-clusters based on the device graph, the person-clusters based on the links and community detection hyperparameter values, generate a node-to-person lookup structure based on the person-clusters, and deduplicate impression data based on the node-to-person lookup structure.

Example 2 includes the apparatus of example 1, wherein the links between the ones of the personally identifiable information and the ones of the device nodes are from a database proprietor.

Example 3 includes the apparatus of example 1, wherein the community detection hyperparameter values include a first hyperparameter value to control size of the person-clusters and a second hyperparameter value to control a size variance between the person-clusters.

Example 4 includes the apparatus of example 1, wherein the processor circuitry is to execute the instructions to create a second device graph based on the node-to-person lookup structure.

Example 5 includes the apparatus of example 1, wherein the processor circuitry is to execute the instructions to generate the person-clusters based on a degree to which first nodes of the device graph interact among themselves relative to interactions between the first nodes and second nodes.

Example 6 includes the apparatus of example 5, wherein the first nodes include a first portion of the personally identifiable information nodes and a first portion of the device nodes, the second nodes to include a second portion of the personally identifiable information nodes and a second portion of the device nodes.

Example 7 includes the apparatus of example 1, wherein at least one of the personally identifiable information nodes or the device nodes includes demographic information.

Example 8 includes the apparatus of example 7, wherein the generating of the person-clusters is based on the demographic information.

Example 9 includes the apparatus of example 1, wherein the processor circuitry is to execute the instructions to determine, before the generating of the person-clusters, an initial value of an objective function, determine, after the generating of the person-clusters, a final value of the objective function, compare the initial value of the objective function with the final value of the objective function, generate second person-clusters based on the comparison, and deduplicate the impression data based on a second node-to-person lookup structure, the second node-to-person lookup structure based on the second person-clusters.

Example 10 includes at least one non-transitory computer readable storage medium comprising instructions that, when executed, cause at least one processor to at least generate a device graph, the device graph to represent links between ones of personally identifiable information nodes and ones of device nodes, generate person-clusters based on the device graph, the person-clusters based on the links and community detection hyperparameter values, generate a node-to-person lookup structure based on the person-clusters, and deduplicate impression data based on the node-to-person lookup structure.

Example 11 includes the at least one non-transitory computer readable storage medium of example 10, wherein the links between the ones of the personally identifiable information and the ones of the device nodes are from a database proprietor.

Example 12 includes the at least one non-transitory computer readable storage medium of example 10, wherein the hyperparameter values include a first hyperparameter value to control size of the person-clusters and a second hyperparameter value to control a size variance between the person-clusters.

Example 13 includes the at least one non-transitory computer readable storage medium of example 10, wherein the instructions are to cause the at least one processor to create a second device graph based on the node-to-person lookup structure.

Example 14 includes the at least one non-transitory computer readable storage medium of example 10, wherein the instructions are to cause the at least one processor to generate the person-clusters based on a degree to which first nodes of the device graph interact among themselves relative to the first nodes interacting with second nodes.

Example 15 includes the at least one non-transitory computer readable storage medium of example 14, wherein the first nodes include a first portion of the personally identifiable information nodes and a first portion of the device nodes, the second nodes to include a second portion of the personally identifiable information nodes and a second portion of the device nodes.

Example 16 includes the at least one non-transitory computer-readable storage medium of example 10, wherein at least one of the personally identifiable information nodes or the device nodes includes demographic information.

Example 17 includes the at least one non-transitory computer readable storage medium of example 16, wherein the instructions are to cause the at least one processor to generate the person-clusters based on the demographic information.

Example 18 includes the at least one non-transitory computer readable storage medium of example 10, wherein the instructions are to cause the at least one processor to determine, before the generating of the person-clusters, an initial value of an objective function, determine, after the generating of the person-clusters, a final value of the objective function, compare the initial value of the objective function with the final value of the objective function, generate second person-clusters based on the comparison, and deduplicate the impression data based on a second node-to-person lookup structure, the second node-to-person lookup structure based on the second person-clusters.

Example 19 includes a method, comprising generating a device graph the device graph to represent links between ones of personally identifiable information nodes and ones of device nodes, generating person-clusters based on the device graph, the person-clusters based on the links and community detection hyperparameter values, generating a node-to-person lookup structure based on the person-clusters, and deduplicate impression data based on the node-to-person lookup structure.

Example 20 includes the method of example 19, wherein the links between the ones of the personally identifiable information nodes and the ones of the device nodes are from a database proprietor.

Example 21 includes the method of example 19, wherein the hyperparameter values include a first hyperparameter value to control size of the person-clusters and a second hyperparameter value to control a size variance between the person-clusters.

Example 22 includes the method of example 19, further including creating a second device graph based on the node-to-person lookup structure.

Example 23 includes the method of example 19, further including generating the person-clusters based on a degree to which first nodes of the device graph interact among themselves relative to the first nodes interacting with second nodes.

Example 24 includes the method of example 23, wherein the first nodes include a first portion of the personally identifiable information nodes and a first portion of the device nodes, the second nodes including a second portion of the personally identifiable information nodes and a second portion of the device nodes.

Example 25 includes the method of example 19, wherein at least one of the personally identifiable information nodes or the device nodes includes demographic information.

Example 26 includes the method of example 25, wherein the generating of the person-clusters is based on the demographic information.

Example 27 includes the method of example 19, further including determining, before the generating of the person-clusters, an initial value of an objective function, determining, after the generating of the person-clusters, a final value of the objective function, comparing the initial value of the objective function with the final value of the objective function, generating second person-clusters based on the comparison, and deduplicate the impression data is based on a second node-to-person lookup structure, the second node-to-person lookup structure based on the second person-clusters.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. An apparatus comprising:
at least one memory;
instructions; and
processor circuitry to execute the instructions to:
generate a device graph, the device graph to represent links between ones of personally identifiable information nodes and ones of device nodes;
generate person-clusters based on the device graph, the person-clusters based on the links and community detection hyperparameter values;
generate a node-to-person lookup structure based on the person-clusters; and
deduplicate impression data based on the node-to-person lookup structure.

2. The apparatus of claim 1, wherein the links between the ones of the personally identifiable information nodes and the ones of the device nodes are from a database proprietor.

3. The apparatus of claim 1, wherein the community detection hyperparameter values include a first hyperparameter value to control size of the person-clusters and a second hyperparameter value to control a size variance between the person-clusters.

4. The apparatus of claim 1, wherein the processor circuitry is to execute the instructions to create a second device graph based on the node-to-person lookup structure.

5. The apparatus of claim 1, wherein the processor circuitry is to execute the instructions to generate the person-clusters based on a degree to which first nodes of the device graph interact among themselves relative to interactions between the first nodes and second nodes.

6. The apparatus of claim 5, wherein the first nodes include a first portion of the personally identifiable information nodes and a first portion of the device nodes, the second nodes to include a second portion of the personally identifiable information nodes and a second portion of the device nodes.

7. The apparatus of claim 1, wherein at least one of the personally identifiable information nodes or the device nodes includes demographic information.

8. The apparatus of claim 7, wherein the generating of the person-clusters is based on the demographic information.

9. The apparatus of claim 1, wherein the processor circuitry is to execute the instructions to:
determine, before the generating of the person-clusters, an initial value of an objective function;
determine, after the generating of the person-clusters, a final value of the objective function;
compare the initial value of the objective function with the final value of the objective function;
generate second person-clusters based on the comparison; and
deduplicate the impression data based on a second node-to-person lookup structure, the second node-to-person lookup structure based on the second person-clusters.

10. At least one non-transitory computer readable storage medium comprising instructions that, when executed, cause at least one processor to at least:
generate a device graph, the device graph to represent links between ones of personally identifiable information nodes and ones of device nodes;
generate person-clusters based on the device graph, the person-clusters based on the links and community detection hyperparameter values;
generate a node-to-person lookup structure based on the person-clusters; and
deduplicate impression data based on the node-to-person lookup structure.

11. The at least one non-transitory computer readable storage medium of claim 10, wherein the links between the ones of the personally identifiable information nodes and the ones of the device nodes are from a database proprietor.

12. The at least one non-transitory computer readable storage medium of claim 10, wherein the hyperparameter values include a first hyperparameter value to control size of the person-clusters and a second hyperparameter value to control a size variance between the person-clusters.

13. The at least one non-transitory computer readable storage medium of claim 10, wherein the instructions are to cause the at least one processor to create a second device graph based on the node-to-person lookup structure.

14. The at least one non-transitory computer readable storage medium of claim 10, wherein the instructions are to cause the at least one processor to generate the person-clusters based on a degree to which first nodes of the device graph interact among themselves relative to the first nodes interacting with second nodes.

15. The at least one non-transitory computer readable storage medium of claim 14, wherein the first nodes include a first portion of the personally identifiable information nodes and a first portion of the device nodes, the second nodes to include a second portion of the personally identifiable information nodes and a second portion of the device nodes.

16. The at least one non-transitory computer-readable storage medium of claim 10, wherein at least one of the personally identifiable information nodes or the device nodes includes demographic information.

17. The at least one non-transitory computer readable storage medium of claim 16, wherein the instructions are to cause the at least one processor to generate the person-clusters based on the demographic information.

18. The at least one non-transitory computer readable storage medium of claim 10, wherein the instructions are to cause the at least one processor to:
determine, before the generating of the person-clusters, an initial value of an objective function;
determine, after the generating of the person-clusters, a final value of the objective function;
compare the initial value of the objective function with the final value of the objective function;
generate second person-clusters based on the comparison; and
deduplicate the impression data based on a second node-to-person lookup structure, the second node-to-person lookup structure based on the second person-clusters.

19. A method, comprising:
generating a device graph, the device graph to represent links between ones of personally identifiable information nodes and ones of device nodes;
generating person-clusters based on the device graph, the person-clusters based on the links and community detection hyperparameter values;
generating a node-to-person lookup structure based on the person-clusters; and
deduplicate impression data based on the node-to-person lookup structure.

20. The method of claim 19, wherein the links between the ones of the personally identifiable information nodes and the ones of the device nodes are from a database proprietor.

21. The method of claim 19, wherein the hyperparameter values include a first hyperparameter value to control size of the person-clusters and a second hyperparameter value to control a size variance between the person-clusters.

22. The method of claim 19, further including creating a second device graph based on the node-to-person lookup structure.

23. The method of claim 19, further including generating the person-clusters based on a degree to which first nodes of the device graph interact among themselves relative to the first nodes interacting with second nodes.

24. The method of claim 23, wherein the first nodes include a first portion of the personally identifiable information nodes and a first portion of the device nodes, the second nodes including a second portion of the personally identifiable information nodes and a second portion of the device nodes.

25. The method of claim 19, wherein at least one of the personally identifiable information nodes or the device nodes includes demographic information.

26. The method of claim 25, wherein the generating of the person-clusters is based on the demographic information.

27. The method of claim 19, further including:
determining, before the generating of the person-clusters, an initial value of an objective function;
determining, after the generating of the person-clusters, a final value of the objective function;
comparing the initial value of the objective function with the final value of the objective function;
generating second person-clusters based on the comparison; and
deduplicating the impression data based on a second node-to-person lookup structure, the second node-to-person lookup structure based on the second person-clusters.
